(19) United States
(12) Patent Application Publication
(10) Pub. No.: US 2006/0240201 A1
(43) Pub. Date: Oct. 26, 2006

(54) Ink-jet recording medium and method of manufacturing the same

(75) Inventors: Kimie Tachibana, Tokyo (JP); Kazumasa Matsumoto, Tokyo (JP); Makoto Kaga, Tokyo (JP); Masayoshi Yamauchi, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA HOLDINGS, INC., Tokyo (JP)

(21) Appl. No.: 11/405,055

(22) Filed: Apr. 17, 2006

(30) Foreign Application Priority Data
Apr. 26, 2005 (JP) JP2005-127670

(51) Int. Cl. B41M 5/00

(52) U.S. Cl. 428/32.21

(57) ABSTRACT

An object of the present invention is to provide an ink-jet recording medium and a manufacturing method thereof exhibiting excellent outdoor durability, high gloss, and high image quality, accompanied with excellent cockling resistance. Also disclosed is an ink-jet recording medium possessing a support made of cellulose pulp as a component, having surface roughness Ra of at least 0.05 μm and at most 0.20 μm when a reference length is 4 mm, and a cut-off value is 0.8 mm, a layer formed by coating a coating solution containing a resin dissolved in an organic solvent, provided on the support, and an ink-absorbing layer is provided on the layer formed by coating the coating solution containing the resin dissolved in the organic solvent.

This application claims priority from Japanese Patent Application No. 2005-127670 filed on Apr. 26, 2005, which is incorporated hereinto by reference.

### TECHNICAL FIELD

The present invention relates to an ink-jet recording medium and a manufacturing method thereof in which a layer containing a solvent based resin is provided on a highly flat paper support, and an ink-absorbing layer is provided on the layer, and also to the ink-jet recording medium and the manufacturing method capable of exhibiting excellent outdoor durability, accompanied with excellent cockling resistance at the time of manufacturing as well as during printing.

### BACKGROUND

In recent years, image quality obtained via an ink-jet recording method has been approaching to that of silver halide photography, since an ink-jet image improving technology is rapidly in progress. Usable ink-jet recording media are also tried to be rapidly improved at the same time in order to achieve such the photographic image via the ink-jet recording media.

It is commonly known that supports used for ink-jet recording media are classified into absorbable supports made of paper and the like, and unabsorbable supports made of polyester, or resin-coated paper.

The former absorbable supports which are porous supports including plain paper, fine-quality paper, coated paper, and cast-coat paper, for example, have an advantage of exhibiting high ink-absorbing capability since the support itself is capable of absorbing ink, whereas it is seen as a problem that cockles (referred to also as cockling) caused by absorbability of the support are generated at the time of manufacturing as well as during printing. In the case of employing dye as a colorant for ink, no maximum density can be achieved because of penetration of dye into a support, whereby sharp images are difficult to be acquired, to obtain high quality prints. There is further another problem that scratches on the print surface caused by an ink-jet recording head, originated by cockling during printing, are easily generated. In order to solve the above-described problem, proposed is a method, for example, in which cockling is improved by providing an intermediate layer containing a pigment and an adhesive having a glass transition temperature of 30-60° C. between a plain paper support and an ink-absorbing layer (refer to Patent Document 1, for example), but further improvements are now desired since the effects are still immature.

On the other hand, the latter unabsorbable supports result in no problem described above, and have an advantage of obtaining high quality prints. Unabsorbable supports are classified into plastic resin film supports, and supports of which both surfaces of paper are covered by a plastic resin film. The latter is particularly useful in view of readily obtaining high quality prints. Typically provided is a support of which both surfaces of paper are covered by a polyolefin resin to realize highly glossy photographic images by providing a porous ink-absorbing layer on this support (refer to Patent Document 2, for example).

(Patent Document 1) Japanese Patent O.P.I. Publication No. 5-85035

(Patent Document 2) Japanese Patent No. 3321700

### SUMMARY

Though an ink-jet recording medium having a support of which both surfaces of paper are covered by a polyolefin resin as described in Patent Document 2 is capable of providing high quality printed images originated by high gloss and flatness of the support, it has been found out that this ink-jet recording medium results in insufficient outdoor durability. When an ink-jet recording medium having a porous ink-absorbing layer provided on a support of which a polyethylene resin is coated onto both surfaces of paper by an extrusion coating method, for example, is placed outside standing for 1-2 months, the film surface is peeled off. This is a phenomenon caused by a polyethylene resin peeled off from not a porous ink-absorbing layer itself, but paper of the support.

Accordingly, it is an object of the present invention to provide an ink-jet recording medium and a manufacturing method thereof capable of exhibiting excellent outdoor durability, high gloss, and high image quality, resulting in excellent cockling resistance.

### DESCRIPTION OF THE PREFERRED EMBODIMENTS

The above object of the present invention is accomplished by the following structures.

(Structure 1) An ink-jet recording medium possessing a support made of cellulose pulp as a component, having surface roughness Ra of at least 0.05 m and at most 0.20 μm when a reference length is 4 mm, and a cut-off value is 0.8 mm, a layer formed by coating a coating solution containing a resin dissolved in an organic solvent, provided on the support, and an ink-absorbing layer is provided on the layer formed by coating the coating solution containing the resin dissolved in the organic solvent.

(Structure 2) An ink-jet recording medium possessing a support made of cellulose pulp as a component, having surface roughness Ra of at least 0.05 μm and at most 0.20 μm when a reference length is 4 mm, and a cut-off value is 0.8 mm, a layer having a thickness of at least 0.50 μm and at most 20 μm, formed by coating a coating solution containing a resin dissolved in an organic solvent, provided on the support, and an ink-absorbing layer is provided on the layer having a thickness of at least 0.50 μm and at most 20 μm.

(Structure 3) The ink-jet recording medium of Structure 1 or 2, wherein a layer is formed by coating a coating solution containing a resin dissolved in an organic solvent on an opposite surface of a support surface on which the layer is formed by coating the coating solution containing the resin dissolved in the organic solvent.

(Structure 4) The ink-jet recording medium of any one of Structures 1-3, wherein the ink-absorbing layer is formed by coating a coating solution in which water or alcohol is used as a solvent.

(Structure 5) The ink-jet recording medium of any one of Structures 1-4, wherein the resin dissolved in the organic solvent contains a hydrophilic group.

(Structure 6) The ink-jet recording medium of any one of Structures 1-5, wherein the ink-absorbing layer is a porous ink-absorbing layer.

(Structure 7) The ink-jet recording medium of Structure 6, wherein the porous ink-absorbing layer contains at least inorganic particles and organic binder.

(Structure 8) The ink-jet recording medium of any one of Structures 1-7, wherein the support is made of cast-coat paper.

(Structure 9) A method of manufacturing an ink-jet recording medium possessing a support made of cellulose pulp as a component, having surface roughness Ra of at least 0.05 μm and at most 0.20 μm when a reference length is 4 mm, and a cut-off value is 0.8 mm, a layer formed by coating a coating solution containing a resin dissolved in an organic solvent, provided on the support, and an ink-absorbing layer is provided on the layer formed by coating the coating solution containing the resin dissolved in the organic solvent.

(Structure 10) A method of manufacturing an ink-jet recording medium possessing a support made of cellulose pulp as a component, having surface roughness Ra of at least 0.05 μm and at most 0.20 μm when a reference length is 4 mm, and a cut-off value is 0.8 mm, a layer having a thickness of at least 0.50 μm and at most 20 μm, formed by coating a coating solution containing a resin dissolved in an organic solvent, provided on the support, and an ink-absorbing layer is provided on the layer having a thickness of at least 0.50 μm and at most 20 μm.

(Structure 11) The method of manufacturing an ink-jet recording medium of Structure 9 or 10, wherein a layer is formed by coating a coating solution containing a resin dissolved in an organic solvent on an opposite surface of a support surface on which the layer is formed by coating the coating solution containing the resin dissolved in the organic solvent.

(Structure 12) The method of manufacturing an ink-jet recording medium of any one of Structures 9-11, wherein the ink-absorbing layer is formed by coating a coating solution in which water or alcohol is used as a solvent.

(Structure 13) The method of manufacturing an ink-jet recording medium of any one of Structures 9-12, wherein the resin dissolved in the organic solvent contains a hydrophilic group.

(Structure 14) The method of manufacturing an ink-jet recording medium of any one of Structures 9-13, wherein the ink-absorbing layer is a porous ink-absorbing layer.

(Structure 15) The method of manufacturing an ink-jet recording medium of Structure 14, wherein the porous ink-absorbing layer contains at least inorganic particles and organic binder.

(Structure 16) The method of manufacturing an ink-jet recording medium of any one of Structures 9-15, wherein the support is made of cast-coat paper.

While the preferred embodiments of the present invention have been described using specific terms, such description is for illustrative purposes only, and it is to be understood that changes and variations may be made without departing from the spirit or scope of the appended claims.

### DETAILED DESCRIPTION OF THE INVENTION

Next, the most preferable embodiment of this invention will be detailed.

After considerable effort during intensive studies, the inventors have found out an ink-jet recording medium possessing a support made of cellulose pulp as a component, having surface roughness Ra of at least 0.05 μm and at most 0.20 μm when a reference length is 4 mm, and a cut-off value is 0.8 mm, a layer formed by coating a coating solution containing a resin dissolved in an organic solvent, provided on the support (hereinafter, referred to also as “a resin layer of the present invention”), and an ink-absorbing layer is provided on the layer, as described in Structure 1; and also the ink-jet recording medium and the manufacturing method thereof as described in Structure 9, resulting in excellent outdoor durability, high gloss, and high image quality, accompanied with excellent cockling resistance.

The inventors have found out that it is desired that a water-soluble solvent such as water or alcohol to swell cellulose pulp in a support is not brought into contact with cellulose for a long duration, in order to improve image clarity as a factor contributing to excellent image formation. That is, it is found out that cockling at the time of manufacturing as well as during printing is suppressed by forming an ink-absorbing layer after forming a water resistance coated layer containing a resin with a solvent in which cellulose of base paper is not swelled.

It is a feature of a support with a water resistance coated layer containing a resin of the present invention that the water penetrating speed is slower than the water removing speed via drying when a water-soluble coating solution used for forming layers such as an ink-absorbing layer and the like is specifically coated, whereby cockling of a paper support made of cellulose pulp as a main component is difficult to occur. When images are formed by employing water-soluble ink used for an ink-jet recording medium of the present invention, penetration of moisture in the water-soluble ink into the paper support is avoided, whereby no cockling after printing occurs.

No cockling occurs since the coating solution is further an organic solvent based solution, and a chemical bond of cellulose in the paper support is not broken, even though a solvent is penetrated into the paper support during coating on the paper support.

High gloss is particularly desired to obtain high image quality. It is found out that in the case of employing a flat paper support having a value of specific surface roughness to realize the foregoing, the flatness is not deteriorated, and the resin layer surface exhibits high gloss, whereby the resulting recording medium exhibits high image quality.

By providing a layer containing a resin dissolved in an organic solvent other than solvents to swell cellulose such as water or alcohol on a support made of cellulose pulp as a main component, having surface roughness Ra of at least 0.05 μm and at most 0.20 μm when a reference length is 4 mm, and a cut-off value is 0.8 mm, a solvent in a coating solution used for forming an ink-absorbing layer provided thereon is shut off to avoid swelling of paper cellulose, or swelling of base paper caused by a solvent (water or alcohol) to swell cellulose contained in ink employed during printing is suppressed, whereby cockling can also be suppressed.

It is possible to avoid failure generated in surface flatness treatment such as calendar roller stain of a calendar finishing apparatus, since a highly flat ink-jet recording medium is obtained employing a highly flat support of the present invention.

As described in Structures 4 and 12, when an ink-absorbing layer is formed by coating a coating solution using a solvent such as water or alcohol, water or alcohol as a solvent in the coating solution is shut off by a resin layer of the present invention to avoid swelling of paper cellulose.

When a resin layer is formed on a support of the present invention by coating a coating solution containing a resin dissolved in an organic solvent, a resin layer and base paper are considered to be rigidly bonded since the resin dissolved in an organic solvent is penetrated into spacing between cellulose fibers in the support, and the resin is intertwined with the fibers, whereby film peeling between the resin layer and base paper can be avoided, resulting in drastic improvement of outdoor durability.

Described in Structures 2 and 10 are an ink-jet recording medium possessing a support made of cellulose pulp as a component, having surface roughness Ra of at least 0.05 μm and at most 0.20 μm when a reference length is 4 mm, and a cut-off value is 0.8 mm, a layer having a thickness of at least 0.50 μm and at most 20 μm, formed by coating a coating solution containing a resin dissolved in an organic solvent, provided on the support, and an ink-absorbing layer is provided on the layer having a thickness of at least 0.50 μm and at most 20 μm; and a manufacturing method thereof. This gives excellent properties such as outdoor durability, gloss, and high image quality, accompanied with excellent cockling resistance. An ink-jet recording medium and the manufacturing method exhibiting curl resistance together with texture of paper are further found out. More specifically, when a layer formed by coating a coating solution containing a resin dissolved in an organic solvent has at least 0.50 μm and at most 20 μm in thickness, curl resistance at the time of humidity variations, as well as particularly at low humidity is excellent to provide an ink-jet recording medium exhibiting texture.

In the case of a resin layer of the present invention having a thickness of at least 0.05 μm (hereinafter, referred to also as a dry thickness), it is preferable that curl resistance in storage is also excellent, since the moisture penetration prevention is largely effective, occurrence of cockling is sufficiently suppressed, and moisture penetration into raw paper can be sufficiently avoided.

In the case of a resin layer of the present invention having a thickness of at least 0.05 μm, curl of the recording medium can be avoided by adding sufficient stiffness into an ink-jet recording medium of the present invention. The recording medium tends to be expanded or contracted since moisture is absorbed or released in the ink-absorbing layer via humidity variations during storing the ink-jet recording medium having an ink-absorbing layer of the present invention. Though the printing stain caused by head-touching during transportation in a printer is produced by generating curl contracted on the ink-absorbing layer side particularly at low humidity, this problem can be avoided by preparing a resin layer of the present invention having a thickness thicker than a given thickness.

In the case of a resin layer of the present invention having a thickness of at most 20 μm, an ink-jet recording medium exhibiting texture of paper can be obtained. More specifically, an ink-jet recording medium of the present invention differs from a plastic support in that a paper feature accompanied with texture is provided, and in the case of the resin layer having a thickness of at most 20 μm, a feature equivalent to silver halide photography together with less hardness and grainy feeling can be considerably prepared. In consideration of this, it is preferable that the resin layer of the present invention has a thickness of at most 10 μm.

Accordingly, it is more preferable that the resin layer of the present invention has a thickness of 0.5-10 μm in order to solve the problem of the present invention.

Next, as described in Structures 3 and 11, regarding an ink-jet recording medium possessing a support made of cellulose pulp as a component, having surface roughness Ra of at least 0.05 μm and at most 0.20 μm when a reference length is 4 mm, and a cut-off value is 0.8 mm; a layer formed by coating a coating solution containing a resin dissolved in an organic solvent, provided on the support (hereinafter, referred to also as a resin layer on the front surface side); and an ink-absorbing layer is provided on the layer, and a layer formed on the back surface by coating a coating solution containing a resin dissolved in an organic solvent (hereinafter, referred to also as a resin layer on the back surface side), the preparation order of a resin layer on the front surface side, an ink-absorbing layer on the front surface side, and a resin layer on the back surface side is not limited. Accordingly, the resin layer on the front surface side, the ink-absorbing layer on the front surface side, and the resin layer on the back surface side may be prepared in this order, and the resin layer on the back surface side, the resin layer on the front surface side, and the ink-absorbing layer on the front surface side may also be prepared in this order.

Since penetration of a water-soluble solvent from the back surface is suppressed by providing a resin layer also on the back surface as described above, occurrence of cockling during production can be largely suppressed, whereby generation of curl can be suppressed by balancing both the front and back surfaces. A level of no moisture penetration at high humidity in the storage environment of the ink-jet recording medium may be accepted, and it is preferable in this case that a resin layer on the back surface side has a thickness of at least 0.50 μm in thickness. It is also preferable that the resin layer has a thickness of at most 20 μm in thickness in view of texture. Concerning the thickness relationship between the resin layers on the front and back surface sides, a thicker resin layer on the back surface side than on the front surface side is desired in view of suppression of curl caused by expansion and contraction of an ink-absorbing layer provided on the resin layer on the front surface side. Further, thickness of the resin layer on the back surface side is preferably 1.1-2 times thicker than that of the resin layer on the front surface side. In the case of forming the resin layers on the front and back surface sides, having the same composition, the total thickness of both the resin layers is preferably at most 20 μm in view of the ink-jet recording medium exhibiting a paper feature accompanied with texture.

As described in Structures of 1, 2, 9, and 10, it is preferred that a resin layer on the front surface side is capable of exhibiting hydrophilicity in order to enhance adhesion between an ink-absorbing layer and the resin layer on the front surface side. It is preferable, for example, that the resin layer on the front surface side is subjected to hydrophilic treatment such as corona discharge treatment or electron beam treatment, or an adhesive layer (a subbing layer such as a hydrophilic binder layer or such made of gelatin) is provided. As described in Structures 5 and 13, it is preferable that a resin dissolved in an organic solvent contains a hydrophilic group. When the resin layer on the front surface side itself is hydrophilic, affinity for a water-soluble coating solution used for an ink-absorbing layer coated on the resin layer results, whereby adhesion is considered to be largely enhanced.

The present invention of Structures 6 and 14 relates to an ink-jet recording medium of any one of Structures 1-5 and 9-13, wherein an ink-absorbing layer is a porous layer. Though a swelling type layer or a porous structure type layer can be provided as an ink-absorbing layer, a porous structure type ink-absorbing layer is preferable in the present invention in order to achieve high image quality.

The present invention of Structures 7 and 15 relates to an ink-jet recording medium and a manufacturing method thereof according to Structures 6 and 14, wherein a porous ink-absorbing layer is made of at least inorganic particles and organic binder, and it is particularly preferred that a porous layer formed in this manner is possible to realize high image quality.

The present invention of Structures 8 and 16 relates to an ink-jet recording medium of any one of Structures 1-7 and 9-15, wherein a support is made of cast-coat paper. It is preferable that an ink-jet recording medium exhibiting marked effects of the present invention can be produced by forming a resin layer and an ink-absorbing layer of the present invention, employing cast-coat paper having surface flatness for printing as a support.

Next, the present invention will be detailed.

A support used for paper-making in the present invention which is made of natural pulp like wood pulp as a raw material is produced by mixing one kind or at least two kinds of synthetic pulp such as polypropylene and the like; synthetic fibers such as nylon and polyester; recycled pulp, and wood pulp. Preferably usable is an inorganic substance pulp, and examples of cellulose pulp used in this manufacture include chemical pulp, semichemical pulp, semi mechanical pulp, and mechanical pulp such as sulfite pulp (SP), alkaline pulp (AP), and kraft pulp (KP) which are made of broad leaf tree or needle-leaved tree. Recycled paper pulp as deinked secondary fibers is also usable. Pulp is usable regardless of bleached or unbleached pulp, and also of beating or non-beating. Examples of usable fibers such as grass, leaf, bast and seed hair fibers as non-wood pulp also include straw, bamboo, hemp, bagasse, kenaf, edgeworthia chrysantha, cotton linter, reed, esparto, and banana. Though recycled fibers such as rayon and the like; and hydrophilic synthetic polymer fibers such as cellulose derivative fibers, polyvinyl alcohol and polyacrylamide are further usable as hydrophilic fibers, broad leaf tree bleached kraft pulp (hereinafter, referred to also as LBKP) or needle-leaved tree bleached kraft pulp is most preferable in view of quality and cost.

It is possible to add various types of commonly known additives, for example, sizing agent, pigments, paper strength enhancing agents, fixing agents, fluorescent whitening agents, wet paper strength enhancing agents, cationizing agents into the paper support, if desired. It is possible to add higher order fatty acids and alkylketene dimmer, for example, as the sizing agent; to add calcium carbonate, talc, titanium oxide, for example, as the pigment; to add starch, polyacrylamide and polyvinyl alcohol, for example, as the paper strength enhancing agent; and to add aluminum sulfate or cationic polymer electrolyte material as the fixing agent, but the present invention is not limited thereto.

Freeness of pulp utilized in paper-making is preferably 200-500 ml based on the definition of CSF, and fiber length after beating is preferably 30-70% as the sum of 24 mesh residue and 42 mesh residue specified in JIS P 8207. Herein, 4 mesh residue is preferably not more than 20%.

Paper weight per m² is preferably 50-250 g, and more preferably 70-200 g. The paper thickness is preferably 50-210 μm.

Paper density is generally 0.7-1.2 g/cm³ (JIS P 8118). Further, raw paper stiffness is preferably 20-200 g according to the condition specified in JIS P 8143.

A surface sizing agent may be coated on the paper surface.

The pH of paper is preferably 5-9 in the case of measuring via a hot water extraction method specified in JIS P 8113.

It is preferred in view of environmental consciousness that recycled paper pulp is positively used for a support containing cellulose pulp as a component employed in the present invention. Thus, depletion of wood resource as a raw material is suppressed to obtain environmental conscious products. It is preferred that a support containing cellulose pulp as a component employed in the present invention contains preferably 20-100% in recycled paper, based on the total raw material, more preferably 80-100%, and particularly 100% to prepare recycled paper via paper-making.

Incidentally, though a deinking agent is mixed in the case of employing recycled paper, a fatty acid based surfactant or a high alcohol derivative is typically usable as a deinking agent. In recent years, the latter high alcohol derivative has been utilized, and it is desired that the content of deinking agent in such the recycled paper is 50 ppm or less.

Though commonly known paper machines such as a fourdrinier paper machine, a cylinder paper machine and a twin-wire paper machine are utilized for raw paper-making used for ink-jet recording sheets of the present invention, it is effective to adopt appropriate paper-making methods as cited in Japanese Patent O.P.I. Publication Nos. 58-37642, 61-260240, and 61-284762. In order to obtain high flatness, it is preferred that raw paper is calendar finishing-processed after paper-making, and specifically thermal calendar finishing is conducted under the conditions of a temperature of 150-300° C. and a linear pressure of 150-1500 N/cm. In the case of a temperature of 150° C. or more, flatness appears prominently, and in the case of a temperature of 300° C. or less, no scorching of paper is observed. Further in the case of a linear pressure of 150 N/cm or more, high flatness is acquired, and particularly in the case of a linear pressure of 400 N/cm or more, remarkable flatness is obtained. In the case of a linear pressure of 1500 N/cm or less, paper exhibiting sufficient stiffness can be obtained.

It is a feature that surface roughness (Ra) of a support of the present invention before forming a resin layer prepared by coating a coating solution containing a resin of the present invention is at least 0.05 μm and at most 0.20 μm. When the surface roughness is within this range, not only flatness after coating the resin layer and ink-absorbing layer becomes excellent, but also gloss is further increased.

Surface roughness Ra (referred to as center-average roughness) of the present invention means a value represented by a center-line average roughness obtained via measurement with a reference length of 4.0 mm and a cut-off value of 0.8 mm by the method specified in JIS-B-0601.

Measurement is conducted via a specific average roughness measuring method after wetting measured samples for 24 hours at 25° C. and 65% RH. Surfcom 500B produced by Tokyo Seimitsu Co., Ltd. is employed as a usable measuring apparatus, for example.

As shown in Structures 8 and 16, cast-coat paper is preferably used as a support before forming a resin layer for an ink-jet recording medium of the present invention as described previously. Flatness after coating a resin layer and an ink-absorbing layer becomes satisfactorily better since cast-coat paper exhibits a high flatness property, so that gloss is further increased. Particularly preferable is cast-coat paper for printing among these cast-coat paper sheets. Mirror Coat produced by Oji Paper Co., Ltd. and Esprit Coat produced by Nippon Paper Group, Inc. are employed as the cast-coat paper for printing, for example.

Cast-coat paper is paper produced by a cast-coat method. Provided as a cast-coat method is any one of methods such as a direct method (referred to as a wet method) in which a coated layer is dried by bringing into pressing contact with a heated mirror finished surface roller in a wet state; a congealing method (referred to as a gelation method) in which a coated layer is dried by bringing into pressing contact with a heated mirror finished surface roller after congealing the coated layer with a congealing liquid in a wet state; and a rewet method in which a coated layer is dried by bringing into pressing contact with a heated mirror finished surface roller after a coated layer is dried, followed by rewetting the coated layer again via a wet liquid coating.

A cast-coat layer of cast-coat paper is mainly composed of particles and binder. Examples of particles used for the cast-coat layer include inorganic fillers such as kaolin, talc, soft calcium carbonate, heavy calcium carbonate, magnesium carbonate, aluminium hydroxide, alumina, alumina hydrate, calcium carbonate, titanium dioxide, barium sulfate, calcium sulfate, satin white, zinc sulfide, zinc oxide, zinc carbonate, magnesium hydroxide, zeolite, synthetic amorphous silica, colloidal silica, aluminium silicate, calcium silicate, magnesium silicate, diatom earth, talcum crystallinum (A₂O₃.2SiO₂.2H₂O), and lithopone; and organic fillers such as plastic pigment and so forth.

Examples of binder used for the cast-coat layer include cellulose derivatives such as carboxymethyl cellulose and hydroxyethyl cellulose; starch derivatives such as oxidized starch, esterified starch and phosphate esterified starch; polyvinyl alcohol or a derivative thereof; casein, gelatin, soybean protein, a styrene-maleic acid resin or a derivative thereof; polyvinyl pyrrolidone, a styrene-butadiene copolymer, an acrylic copolymer, and a vinyl acetate based copplymer.

It is a feature that an ink-jet recording medium of the present invention has a resin layer formed by coating a resin dissolved in an organic solvent, provided on the above-described support.

Next, the resin dissolved in an organic solvent in the present invention will be described.

Examples of the resin dissolved in an organic solvent in the present invention include a polyester based resin, a polyurethane based resin (for example, a polyester polyurethane resin, a polyether polyurethane resin, or a polycarbonate polyurthane resin), a polyamide based resin, an acrylic resin, a polyvinylchloride based resin (for example, a vinyl chloride copolymer such as a vinyl chloride-vinyl acetate copolymer, a vinyl chloride-acrylonitrile copolymer or an ethylene-vinyl chloride copolymer; a vinyl chloride resin, and chlorinated polyvinyl chloride), a polyvinylidene chloride based resin (for example, a vinyl chloride-vinylidene chloride copolymer and such), a polyamide based resin, a polyimide based resin, an amine resin, a polycarbonate based resin, a phenol resin, a phenoxy resin, an alkyd resin, a melamine resin, a polyether resin, a polyether sulfone based resin, a butyral resin (for example, polyvinyl butyral), a rosin based resin, a halogenated polyolefin based resin, a polystyrene based resin (for example, a styrene butadiene resin, an acrylonitrile-styrene copolymer, an acrylonitrile-chlorinated polyethylene-styrene coplymer, and a methyl methacrylate-butadiene-styrene copolymer), a urea resin, a maleic acid resin, a petroleum based resin, a rosin ester based resin, an ethylene-vinyl acetate based resin (for example, a vinyl acetate-vinyl alcohol copolymer and such), a styrene-maleic acid resin, an acrylonitrile butadiene based resin, a vinyl chloride-vinyl acetate based resin, an acrylic resin, a styrene-acrylic based resin, a styrene-butadiene based resin, an ethylene-vinyl alcohol based resin, a cellulose based resin (for example, cellulose acetate butyrate, cellulose dieacetate, cellulose triacetate, cellulose propionate, and cellulose nitrate), a polyvinyl acetal resin, a polyvinyl butyral resin, a fumaric acid resin, an epoxy resin, a silicone resin, a fluorine based resin, an admixture of a high molecular weight polyester resin and an isocyanate prepolymer, an admixture of polyester polyol and polyisocyanate, a urea formaldehyde resin, an admixture of a low molecular weight glycol, a high molecular weight diol and isocyanate, and these admixtures. It is preferable that a weight average molecular weight is 1000-200000.

It is preferred that a resin dissolved in an organic solvent contains a hydrophilic group. It is considered by the inventors that this is capable of forming a rigid ink-absorbing layer, since adhesion between a layer containing the resin and a layer formed with a water-soluble coating solution provided on the foregoing resin-containing layer is improved.

In addition, in the case of employing a resin containing no hydrophilic group, it is effective that corona discharge treatment is conducted prior to coating the water-soluble solution, and provided is a subbing layer containing a hydrophilic high molecular compound such as gelatin, polyvinyl alcohol or polyvinyl pyrrolidone as a main component in order to improve adhesion between the resin-containing layer and the layer formed with a water-soluble coating solution. Of these, the corona discharge treatment is preferable.

Preferable are a vinyl chloride copolymer and an urethane resin among resins dissolved in an organic solvent to be used, and a vinyl chloride copolymer, in particular, can be prepared via copolymerization of a copolymerizable monomer containing a hydrophilic group as an alkali salt such as a vinyl chloride monomer or sulfonic acid, and aother copolymerizable monomer if desired. This copolymer is easily synthesized because of vinyl synthesis, and copolymerizable components are possible to be selected in various ways, whereby the copolymer characteristics can be optimally adjusted.

Hydrophilic groups used for preferably usable resins among dissolved resins in organic solvents in the present invention are at least one kind of hydrophilic groups selected from the group of a carboxyl group, a sulfonic acid group, a phosphoric acid group, a hydroxyl group, an epoxy group, an amino group and a thiol group, and alkaline metal salts thereof (alkaline metals such as lithium, potassium and sodium).

The preferable hydrophilic group described above is a sulfonic acid salt or a phosphoric acid salt (alkaline metals specifically such as sodium, potassium and lithium), and particularly preferable is potassium in view of solubility, and reactivity together with yield. Examples of the most preferable resin having the effects of the present invention include a sulfonic acid sodium-containing vinyl chloride based resin (for example, MR110 and MR100 produced by Zeon Corporation) and a sulfonic acid sodium-containing polyurethane (for example, UR8200 and UR8300 produced by Toyobo, Ltd, and XE-1 produced by Takeda Pharmaceutical Co., Ltd.).

Examples of usable organic solvents employed for preparation of a coating solution containing a resin dissolved in an organic solvent in the present invention include an ester based solvent such as ethylacetate or butyl acetate; an aromatic solvent such as benzene, toluene, xylene, methoxybenzene or 1,2-dimetoxybenzene; a higher fatty acid based solvent such as an isononane acid, an isomyristic acid, a hexadecanoic acid, an isopalmitic acid, an oleic acid or an isostearic acid; an ester based solvent; an alcohol based solvent such as methanol, ethanol, isopropanol or t-butyl alcohol; a phenol based solvent such as phenol or parachloro phenol; an amide based solvent such as dimethylformamide, dimethylacetamide or dimethylsulfoxide; a ketone based solvent such as cetone, methylethylketone or cyclohexanone; an ether based solvent such as ethylene glycol monobutylether or the like; a halogenated hydrocarbon based solvent such as chloroform, dichloromethane, dichloroethane, tetrachloroethane, trichloroethylene or tetrachloroethylene, chlorobenzene; a cellosolve based solvent such as ethyl cellosolve or butyl cellosolve; a sulfoxide based solvent; and others such as pyridine, triethylamine, 2-pyrolidone, N-methyl-2-pyrrolidone, acetonitrile, butyronitrile, carbon disulfide and tetrahydrofuran. These may be used singly or be mixed in combination with two kinds or more.

Though each of the above organic solvents is usable, preferred are solvents other than ethylene glycol, diethylene glycol, triethylene glycol and glycerin in view of no change of the hydrogen bonding character accompanied with no degradation of the curl characteristic.

Various additives can also be added by coating a coating solution containing a resin dissolved in an organic solvent in the present invention unless functions of formed layers are damaged.

Surface smoothening treatment in the present invention may be conducted for a layer formed by coating a coating solution containing a resin dissolved in an organic solvent. The surface smoothening treatment that can be used in the present invention can be the calendar finishings using a super calendar, gross calendar, machine calendar, soft calendar, etc. The calendar finishing is that of increasing the gloss of the surface by applying pressure, shear force, and heat by passing the target paper support provided with an emulsion layer through the nip region (the gap) between a metal roller and another roller. As the metal roller, normally a steel roller is used whose surface provided with a protective layer of nickel, chromium, ceramic etc. by flame spray coating, and its surface is polished to a mirror finish. The other roller that is combined with the metal roller can be another metal roller, or an elastic roller, and it is desirable to use an elastic roller from the point of view of uniformity of gloss of the surface of the layer including resin. The elastic roller can be a steel or iron core on which is wound cotton, wool, pulp, etc., which is subjected to a compressing and polishing process, or can be a synthetic resin roller such as a urethane resin roller, an epoxy resin roller, or a polyimide resin roller, or can be an aramid fiber roller.

Next, an ink-absorbing layer formed on a resin layer of the present invention will be described.

It is preferable that an ink-absorbing layer of the present invention is formed by coating a coating solution in which water or alcohol is used as a solvent.

Examples of alcohols include alcohols (such as methanol, ethanol, propanol, isopropanol, butanol, isobutanol, secondary butanol, tertiary butanol, pentanol, hexanol, cyclohexanol and benzyl alcohol), polyvalent alcohols (such as ethylene glycol, diethylene glycol, triethylene glycol, polyethylene glycol, propylene glycol, dipropylene glycol, polypropylene glycol, butylene glycol, hexane diol, pentane diol, glycerin, hexane triol and thiodiglycol), and polyvalent alcohol ethers (such as ethylene glycol monomethyl ether, ethylene glycol monoethyl ether, ethylene glycol monobutyl ether, diethylene glycol monomethyl ether, diethylene glycol monoethyl ether, diethylene glycol monobutylether, propylene glycol monobutyl ether, ethylene glycol monomethyl ether acetate, triethylene glycol monomethylether, triethylene glycol monoethylether, triethylene glycol monobutylether, ethylene glycol monophenyl ether, and propylene glycol monophenyl ether).

In an ink-jet recording medium of the present invention, though a swelling type ink-absorbing layer or a porous structure type ink-absorbing layer as the ink-absorbing layer is provided on a layer containing a resin dissolved in an organic solvent of the present invention, the desirable one is a porous structure type ink-absorbing layer having a porous structure.

A swelling type ink-absorbing layer is constituted mainly from a hydrophilic resin, and ink is absorbed due to the swelling of the hydrophilic resin. Though it is desirable to use cross-linked gelatin as this hydrophilic resin, it is also possible to use other hydrophilic polymers. For example, it is possible to use either singly or as copolymers various types of cross-linked synthetic hydrophilic copolymers such as polyvinyl alcohol, gelatin derivatives, graft polymer of gelatin and other polymers, proteins such as albumin, casein, etc., cellulose derivatives such as hydroxyethyl cellulose, carboxymethyl cellulose, cellulose sulfate ester, etc., sodium alginate, cellulose sulfate ester, sugar derivates such as dextrin, dextran, dextran sulfate, etc., poly-N-vinyl pyrrolidone, polyacrylic acid, polymethacrylic acid, polyacrylamide, polyvinyl imidazole, polyvinyl pyrazole, etc. As gelatin, apart from lime treated gelatin, it is possible to use together acid treated gelatin, and also, it is possible to use gelatin hydrolysate. These hydrophilic resins may be used singly or in combination with several kinds.

Next, the ink-absorbing layer having a porous structure desirably usable in the ink-jet recording medium of the present invention is described below.

The porous structure type ink-absorbing layer can be one in which the porous structure is comprised of inorganic particles and organic binder resin, one in which porous structure is created by phase separation of a polymer, or one in which the porous structure is formed by organic particles and organic binder resin.

In view of ink absorption speed, it is desirable in the present invention to form the porous structure by inorganic particles and organic binder resin in a porous structure type ink-absorbing layer. Further, for water-based in recording, the organic binder resin is desirably a hydrophilic binder resin.

Examples of usable inorganic particles to form pores in the ink-absorbing layer include white pigments such as light calcium carbonate, heavy calcium carbonate, magnesium carbonate, kaolin, clay, talc, calcium sulfate, barium sulfate, titanium dioxide, zinc oxide, zinc hydroxide, zinc sulfide, zinc carbonate, hydrotalcite, aluminum silicate, diatomaceous earth, calcium silicate, magnesium silicate, silica, alumina, colloidal alumina, pseudo-boemite, aluminum hydroxide, lithopon, zeolite and magnesium hydroxide.

An average secondary particle diameter of inorganic particles can be determined as a simple averaged value (number average) by observing particles themselves or particles appearing in the cross section or the surface of an ink-absorbing layer and measuring particle diameters of arbitrary 1000 particles. Herein, a particle diameter of each particle is a diameter of a supposed circle having the same projected area as the particle.

In this invention, as inorganic particles, solid particles, selected from silica, alumina or an alumina hydride, are preferably utilized.

As silica preferably employed in this invention, such as silica and colloidal silica synthesized by an ordinary wet method or silica synthesized by a gas phase method are preferable, however, colloidal silica or particle silica synthesized by a gas phase method are specifically preferably utilized in this invention; among them, particle silica synthesized by a gas phase method is preferable because a high pore ratio can be obtained as well as coarse aggregates are hardly formed when cationic polymer utilized for the purpose of fixing a dye is added. Further, as alumina or alumina hydride may be either crystalline or amorphous, and any form of such as irregular particles, spherical particles and needle-form particles can be utilized.

Inorganic particles are preferably in a state that a particles dispersion before being mixed with cationic polymer is dispersed to primary particles.

In the present invention, a hydrophilic binder can be incorporated in an ink-absorbing layer. Hydrophilic binders utilized in this invention include, for example, polyvinyl alcohol, gelatin, polyethylene oxide, polyvinyl pyrrolidone, polyacrylic acid, polyacrylamide, polyurethane, dextrane, dextrine, colorgienan (such as κ, [symbol] , λ), agar, pulullan, water-soluble polyvinyl butyral, hydroxyehtyl cellulose and carboxymethyl cellulose. These hydrophilic binders may be employed in combination of at least two kinds. It is also preferred that an organic binder resin cross-linked or polymerized via ionizing radiation may be used.

A hydrophilic binder preferably utilized in the present invention is polyvinyl alcohol.

Examples of polyvinyl alcohol, preferably employed in the present invention, include modified polyvinyl alcohols such as polyvinyl alcohol, the end of which is cationically modified, and anionically modified polyvinyl alcohol provided with an anionic group in addition to ordinary polyvinyl alcohol which is prepared by hydrolysis of polyvinyl acetate.

As polyvinyl alcohol prepared by hydrolysis of vinyl acetate, utilized are those having an average polymerization degree of preferably not less than 1,000 and specifically preferably 1,500-5,000. Further, the saponification degree is preferably 70-100% and specifically preferably 80-99.5%.

Cationic modified polyvinyl alcohol includes, for example, polyvinyl alcohol provided with a primary—tertiary amino group or a quaternary ammonium group in the main chain or the side chain of the above-described polyvinyl alcohol, which are described in Japanese Patent O.P.I. Publication No. 61-10483, and can be prepared by saponification of a copolymer of an ethylenic unsaturated monomer provided with a cationic group and vinyl acetate.

Ethylenically unsaturated monomer having a cationic group includes such as trimethyl-(2-acrylamide-2,2-dimethylethyl)ammonium chloride, trimethyl-(3-acrylamide-3,3-dimethylpropyl)ammonium chloride, N-vinylimidazole, N-vinyl-2-methylimidazole, N-(3-dimethylaminopropyl)methacrylamide, hydroxylethyltrimethyl ammonium chloride, trimethyl-(2-methacrylamidepropyl)ammonium chloride and N-(1,1-dimethyl-3-dimethylaminopropyl)acrylamide.

The ratio of a monomer containing cationic modifying group in cationic modified polyvinyl alcohol is 0.1-10 mol % and preferably 0.2-5 mol % against vinyl acetate.

Anionically modified polyvinyl alcohol includes, for example, polyvinyl alcohol having an anionic group as described in Japanese Patent O.P.I. Publication No. 1-206088, a copolymer of vinyl alcohol and a vinyl compound having a water-soluble group as described in Japanese Patent O.P.I. Publication Nos. 61-237681 and 63-307979 and modified polyvinyl alcohol having a water-soluble group as described in Japanese Patent O.P.I. Publication No. 7-285265.

Further, nonionically modified polyvinyl alcohol includes, for example, polyvinyl alcohol derivatives, in which a polyalkylene oxide group is added to a part of vinyl alcohol, as described in Japanese Patent O.P.I. Publication No. 7-9758, and block copolymers of a vinyl compound having a hydrophobic group and vinyl alcohol as described in Japanese Patent O.P.I. Publication No. 8-25795. Polyvinyl alcohol may be employed in combination of at least two kinds with a different polymerization degree or a different kind of modification.

The addition amount of inorganic particles utilized in an ink-absorbing layer is very much dependent on an ink absorption volume, a pore ratio of an ink-absorbing layer, a type of inorganic pigment and a type of a water-soluble binder, however, is generally 5-30 g and preferably 10-25 g, per 1 m² of a recording medium.

Further, the ratio of inorganic particles to a water-soluble binder, which are utilized in an ink-absorbing layer, is generally 2/1-20/1 and specifically preferably 3/1-10/1.

Further, cationic water-soluble polymer provided with a quaternary ammonium group in the molecule may be contained in an ink-absorbing layer, and the addition amount is generally 0.1-10 g and preferably 0.2-5 g, per 1 m² of a recording medium.

In an ink-absorbing layer, the total amount of pores (pore volume) is preferably not less than 20 ml per 1 m² of a recording medium. When the pore volume is less than 20 ml/m², the ink absorption property is good when ink quantity at printing is small, while, when ink quantity becomes large, ink cannot be completely absorbed often resulting in problems of deteriorated image quality and causing retardation in a drying property.

In an ink-absorbing layer provided with an ink retaining ability, a pore volume against a solid volume is designated as a pore ratio. In this invention it is preferable to set a pore ratio to not less than 50%, because pore can be efficiently formed without making the layer thickness unnecessarily large.

In a recording medium of this invention, a polymer compound, comprising a hydrophilic polymer compound which is provided with a plural number of side chains in the main chain and has been irradiated with ionizing rays to make cross-linking bonds between side chains, is preferably incorporated as a hydrophilic binder with respect to further increasing the effects of this invention.

In the present invention, a hydrophilic polymer compound provided with a plural number of side chains in the main chain is a polymer compound which forms cross-linking bonds between side chains by irradiation of ionizing radiation. And the main chain is constituted of at least one type selected from (a) a saponification product of polyvinyl acetate, (b) polyvinyl acetal, (c) polyethylene oxide, (d) polyalkylene oxide, (e) polyvinyl pyrrolidone, (f) polyacrylamide, (g)hydroxyethyl cellulose, (h) methyl cellulose, (i) hydroxypropyl cellulose, (j) a derivative of at least one type of (a)-(i), and (k) a copolymer containing (a)-(j).

These hydrophilic polymer compounds are preferably resins which become hard to be dissolved in water after cross-linking by irradiation of ionizing radiation such as ultraviolet rays and electron rays.

Further, the side chain is preferably constituted of at least one modifying group selected from a photo-dimerization type, a photo-decomposition type, a photo-polymerization type, a photo-modification type and a photo-depolymerization type, and is preferably prepared by modifying at least one type of main chain selected from above (a)-(k).

A hydrophilic polymer compound, provided with a plural number of side chains in the main chain, utilized in this invention does not require such as a polymerization initiator and a polymerization inhibitor for cross-linking as well as can restrain generation of non-reacted free radials after irradiation of ionizing radiation, resulting in restrain deterioration of crack resistance on aging. Further, a network of a porous layer containing a binder comprising a polymer compound, in which a hydrophilic polymer compound, provided with a plural number of side chains in the main chain, of this invention is irradiated by ionizing radiation to form cross-links between side chains, contains a cross-link at a long distance to provide a structure easy to retain many inorganic particles, resulting in uniform film formation with less amount of binder, that is, with a smaller ratio of binder to inorganic particles, different from a three-dimensional structure at a relatively short distance such as a porous network formed only by employing cross-linking agent, and a porous network formed by irradiating ionizing radiation to a hydrophilic polymer compound without a plural number of side chains in the main chain or a hydrophilic polymer compound having a low polymerization degree.

In this manner, since the smaller is the binder ratio against inorganic particles, the pore ratio of an ink-absorbing layer increases to more easily retain ink (absorb ink), it is possible to prepare an ink-jet recording medium provided with a porous layer which exhibits little cracking and peeling off of a recording layer before marking or printing after forming an ink-jet recording medium, and strong resistance against stress by such as bending even after printing or marking, in addition to restrained ink overflow, rapid drying, strong coated film formation and strong bending resistance.

Therefore, prepared can be an ink-jet recording medium exhibiting a high ink absorbability, improved moisture resistance, minimum crease and cracking, in addition to rapid ink drying rate.

Hydrophilic polymer compounds provided with a plural number of side chains in the main chain are preferably a diazo type of photo-dimerization type or those introduced with a cynamoyl group, a stylbazonium group or a stylquinolium group. Further, preferable is resin which can be dyed by a water-soluble dye such as an anionic dye after photo-cross-linking. Such resin, for example, includes resin provided with a cationic group such as a primary to quaternary ammonium group, for example, photosensitive resin (composition) described in such as Japanese Patent O.P.I. Publication Nos. 56-67309, 60-129742, 60-252341, 62-283339 and 1-198615; and resin provided with a group such as an azide group, which becomes an amino group and cationic by a curing process, for example, photosensitive resin (composition) described in Japanese Patent O.P.I. Publication No. 56-67309.

Concretely, for example, preferable is a resin composition which is provided with 2-azide-5-nitrophenylcarbonyloxyethylene structure represented by following formula (I) or 4-azide-3-nitrophenylcarbonyloxyethylene structure represented by following formula (II) in a polyvinyl alcohol structure described in Japanese Patent O.P.I. Publication No. 56-67309.

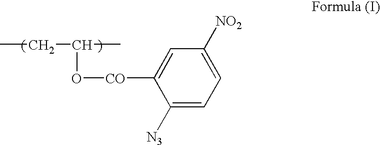

Specific examples of the resin are described in examples 1 and 2 of the publication, and the constituting components of the resin and using ratio thereof are described in page 2 of the publication.

Further, photosensitive resin described in Japanese Patent O.P.I. Publication No. 60-129742 is polyvinyl alcohol type resin provided with a structure unit represented by the following formula (III) or (IV) in a polyvinyl alcohol structure.

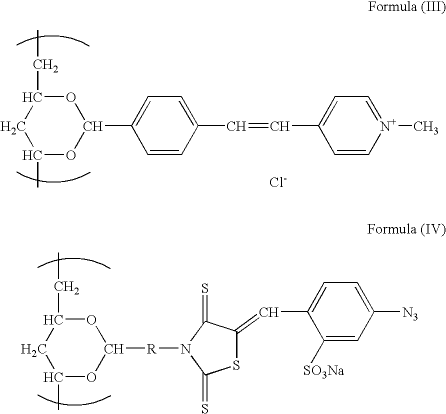

In the formulas, R₁ represents an alkyl group having a carbon number of 1-4 and A⁻ represents an anion. These are polyvinyl alcohol type resins provided with a structural unit having a stylylpyrridinium (stylubazorium) structure or a stylylquinolinium structure, which is prepared by reacting stylylpyrridinium salt or stylylquinorinium salt, having a formyl group, with polyvinyl alcohol or partly saponified polyvinyl acetate, and the manufacturing method is detailed in Japanese Patent O.P.I. Publication No. 60-129742 and can be easily manufactured referring thereto.

The ratio of a stylylpyrridinium group or a stylylquinolinium group in polyvinyl alcohol having a stylylpyrridinium group or a stylylquinolinium group is preferably 0.2-10.0 mol % per vinyl alcohol unit. Solubility into a coating solution can be improved by setting the ratio to not more than 10 mol %. Further, strength after cross-linking will be improved by setting the ratio to not less than 0.2 mol %.

Further, polyvinyl alcohol as a base in the above explanation may partly contain an un-saponified acetyl group and the content of an acetyl group is preferably less than 30%. And a polymerization degree thereof is preferably approximately 300-3000 and more preferably not less than 400. By setting the polymerization degree to not less than 300, irradiation time of radiation for a cross-linking reaction can be shortened resulting in improvement of productivity. Further, by setting the polymerization degree to not more than 3000, increase of viscosity can be restrained resulting in easy handling.

Herein, as a binder, utilized in combination may be a water-soluble resin such as gelatin, polyvinyl pyrrolidone, polyethylene oxide, polyacrylamide and polyvinyl alcohol together with the above-described hydrophilic polymer compound provided with a plural number of side chains in the main chain.

In the present invention, a photo-initiator or a photo-sensitizer is also preferably incorporated. These compounds may be dissolved or dispersed in a solvent, or may be chemically bonded to photosensitive resin.

A photo-initiator or a photo-sensitizer applied is not specifically limited, and those commonly known can be utilized.

A photo-initiator and photo-sensitizer utilized are not specifically limited, however, as an example, include benzophenones such as benzophenone, hydroxybenzophenone, bis-N,N-dimethylaminobenzophenone, bis-N,N-diethylaminobenzophenone, and 4-methoxy-4′-dimethylaminobenzophenone; thioxanthones such as thioxthantone, 2,4-diethylthioxthantone, isopropylthioxthantone, chlorothioxthantone and isopropoxychlorothioxthantone; anthraquinones such as ethylanthraquinone, benzanthraquinone, aminoanthraquinone and chloroanthraquinone; acetophenones; benzoinethers such as benzoinmethylether; 2,4,6-trihalomethyltriazines; 1-hydroxycyclohexyl phenyl ketone; 2,4,5-triarylimidazole dimmers such as a 2-(o-chlorophenyl)-4,5-diphenylimidazole dimer, a 2-(o-chlorophenyl)-4,5-di(m-methoxyphenyl)imidazole dimmer, a 2-(o-fluorophenyl)-4,5-diphenylimidazole dimer, a 2-(o-methoxyphenyl)-4,5-diphenylmidazole dimmer, a 2-(p-methoxyphenyl)-4,5-diphenylmidazole dimmer, a 2-di(p-methoxyphenyl)-5-phenylmidazole dimmer, a 2-(2,4-dimethoxyphenyl)-4,5-diphenylmidazole dimmer; benzyldimethy ketal, 2-benzyl-2-dimethylamino-1-(4-morphorinophenyl)-butane-1-one; 2-methyl-1-[4-(methylthio)phenyl]-2-morphorino-1-propanone; 2-hydroxy-2-mehyl-1-phenyl-propane-1-one; 1-[4-(2-hydroxyethoxy)-phenyl]-2-hydroxy-2-methyl-1-propane-1-one; phenanthrenquinone; 9,10-phenanthrenequinone; benzoins such as methylbenzoin and ethylbenzoin; acrydine derivatives such as 9-phenylacrydine and 1,7-bis(9,9′-acrydinyl)heptane; bisacylphosphine oxide; and mixtures thereof; which may be employed singly or in combination.

Specifically, water-soluble initiators such as 1-[4-(2-hydroxyethoxy)-phenyl]-(2-hydroxy)-2-methyl-1-propane-1-one, 4-(2-hydroxyethoxy)-phenyl-(2-hydroxy-2-propyl)ketone, thioxthantone ammonium salt and benzophenone ammonium salt are preferable with respect to excellent miscibility as well as cross-linking efficiency. Further, in the case of utilizing ultraviolet rays as ionizing radiation, sensitizers such as thioxanthane, benzoin, benzoinalkyletherxanthone, dimehylxanthone, benzophnone, N,N, N′,N′-tetraethyl-4,4′-diaminobenzophenone and 1,1-dichloroacetophenone are preferable.

Herein, when a sensitizer is utilized, the using amount is preferably adjusted to approximately in a range of 0.2-10 weight % and preferably of 0.5-5 weight %, against ionizing radiation curable resin in a coating solution.

An accelerator may be added in addition to these initiators. Examples thereof include p-dimethylamino ethylbenzoate, p-dimethylamino isoamylbenzoate, ethanolamine, diethanolamine and triethanolamine. It may be blended at 0.05-3 weight % against ionizing radiation curable resin in a coating composition.

Cationic polyvinyl alcohol is polyvinyl alcohol provided with a primary to tertiary amino group or a quaternary ammonium group in the main chain or side chain of said polyvinyl alcohol, and can be prepared by saponifying a copolymer of ethylenic unsaturated monomer, which has a cationic group, and vinyl acetate.

Ethylenically unsaturated monomers having a cationic group include such as trimethyl-(2-acrylamido-2,2-dimethylethyl)ammonium chloride, trimethyl-(3-acrylamido-3,3-dimethylpropyl)ammonium chloride, N-vinylimidazole, N-vinyl-2-methylimidazole, N-(3-dimethylaminopropyl)methacrylamide, hydroxyethyl-trimethylammonium chloride, trimethyl-(methacrylamidopropyl)ammonium chloride and N-(1,1-dimethyl-3-dimethylaminopropyl)acrylamide.

After coating a recording medium containing the above-described binder, the coated film is irradiated with ionizing radiation such as ultraviolet rays (a mercury lamp or a metal halide lamp). This irradiation of ionizing radiation causes a cross-linking reaction between side chains of a hydrophilic polymer compound to increase viscosity of a water-based coated film and prevent from being fluidized (so-called to be set), resulting in formation of an uniform coated film. After irradiation of ionizing radiation, the coated film is dried resulting in preparation of an ink-jet recording medium comprising a porous layer provided with pores which primarily contains a hydrophilic binder and particles.

In the present invention, after irradiation of ionizing radiation, a coated layer is preferably dried to evaporate water-based solvents primarily comprising water contained in the coated layer. Concretely, ionizing radiation is irradiated before an ink receiving layer after having been coated is pressing contacted to a heated mirror surface drum. Water-based solvents may be evaporated partly or mostly, however, coated film is preferably irradiated with ionizing radiation in a state of containing a hydrophilic solvent, and irradiation is more preferably performed immediately after the film having been coated. Thereby, since a porous layer can be formed by drying while the coated film is restrained from being fluidized due to cross-linking reaction between side chains of a hydrophilic polymer compound in the coated film, an ink-jet recording medium comprising an uniform porous layer can be prepared.

Ionizing radiation includes, for example, electron rays, ultraviolet rays, alpha rays, beta rays, gamma rays and X rays, and preferably utilized are electron rays and ultraviolet rays which exhibit little effect on a human body and easy handling as well as are prevailing in industrial applications.

In the case of employing electron rays as ionizing irradiation, the irradiation quantity of electron rays is preferably adjusted to approximately in a range of 0.1-20 Mrad. By setting to not less than 0.1 Mrad, a sufficient irradiation effect can be obtained, and by setting to not more than 20 Mrad, deterioration of a support, particularly such as paper or certain plastic, can be restrained. As an irradiation mode of electron rays, such as a scanning mode, a curtain beam mode and a broad beam mode are utilized, and an acceleration voltage at the time of irradiation of electron rays is preferably approximately 100-300 kV. Herein, an electron ray irradiation method exhibits, a higher productivity compared to ultraviolet ray irradiation, without no problem of odor and coloring due to addition of a sensitizer, in addition to advantage of providing a uniform cross-linking structure.

A hydrophilic polymer compound, which is provided with a plural number of side chains in the main chain and preferably utilized in this invention, is capable of being sensitive to such as ultraviolet rays to perform cross-linking reaction without addition of such as the sensitizer described above, and such as an ultraviolet lamp (for example, a low-pressure, a medium-pressure and a high-pressure mercury lamps), a Xenon lamp, a tungsten lamp and a halogen lamp are utilized as a light source of ultraviolet rays, and ultraviolet rays having a strength of approximately 5000-8000 μW/cm² are preferably irradiated. Energy quantity required for curing is in a range of 0.02-20 kJ/cm².

Examples of a method to form pores via polymer phase separation for a recording medium include: (1) a wet phase separation method in which a polymer dissolved in a good solvent is coated on an ink-absorbing layer and then a poor solvent is over coated to generate pores; and (2) a dry phase separation method in which a coating solution containing a polymer, a good solvent of the polymer and a poor solvent of the polymer having a boiling point higher than that of the above good solvent is coated and the solvents are evaporated to dry, resulting in forming pores via micro phase separation.

Examples of the above-described polymer include polymers or cellulose derivatives derived from, for example: an olefin polymer, a vinyl polymer, an acrylic polymer, a styrene polymer, polyester, polyamide, polycarbonate, polyurethane, polysulfone and an epoxide.

Examples of organic particles used in the porous ink-absorbing layer containing organic particles and organic binder resin include: polymethylmethacrylate, a polymer of multifunctional methacrylate, polyamide, polystyrene, polyvinylchloride, chloroprene rubber, nitrile rubber and styrene butadiene rubber.

Examples of the organic binder are common to those used for the porous structure ink-absorbing layer containing inorganic particles and an organic binder resin.

The ink-absorbing layer of the present invention preferably contains a cationic polymer in order to fix a dye-based ink, or as a dispersing agent of inorganic particles. Example of a cationic polymer include: polyethyleneimine, polyallylamine, polyvinylamine, a dicyandiamide polyalkylene polyamine condensate, a polyalkylene polyamine dicyandiamide ammonium salt condensate, a dicyandiamide formalin condensate, an epichlorohydrin dialkylamine addition polymerization product, diallyldimethylammonium chloride polymer, diallyldimethylammonium chloride-SO₂ copolymer, polyvinylimidazole, vinylpyrrolidone-vinylimidazole copolymer, polyvinylpyridine, polyamidine, chitosan, cationized starch, vinylbenzyltrimethylammonium chloride polymer, trimethyl(2-methacryloyloxyethyl)ammonium chloride polymer, dimethylaminoethylmethacrylate polymer. Further, included are: cationic polymers described in “Kagaku kogyo jiho” Aug. 15 and 25, 1998 and polymer dye-fixing agents described in “Polymeric Agents” (1992) published by Sanyo Chemical Industries, Ltd.

Examples of a dispersant of inorganic particles include, in addition to the above cationic polymers, nonionic polymers such as polyacrylic acid and anionic polymers. In this case, a fixing agent for a dye-based ink can be applied by over coating an above-described polymer or a polyvalent metal salt after coating the ink-absorbing layer.

In the ink-absorbing layer of the present invention or in a layer arbitrary provided if necessary, other additives besides those described above may be incorporated, examples of which include: polystyrene, polyacrylic acid ester, polymethacrylic acid ester, polyacrylamide, polyethylene, polypropylen, polyvinylchloride, and copolymers thereof; organic latex particles of, for example, urea resin or melamine resin; anionic, cationic, nonionic and amphoteric surfactants; UV absorbents disclosed in Japanese Patent O.P.I. Publication Nos. 57-74193, 57-87988 and 62-261476; anti-fading agents disclosed in Japanese Patent O.P.I. Publication Nos. 57-74192, 57-87989, 60-72785, 61-146591, 1-95091 and 3-13376; fluorescent whitening agents disclosed in Japanese Patent O.P.I. Publication Nos. 59-42993, 59-52689, 62-280069, 61-242871 and 4-219266; pH adjusting agents such as sulfuric acid, phosphoric acid, citric acid, sodium hydroxide, potassium hydroxide and potassium carbonate; an anti-foaming agent; an antiseptic agent; a thickening agent; an antistatic additive; and a matting agent; which are known in the art.

The ink-absorbing layer may be constituted of two or more layers, and in this case, the composition of those ink-absorbing layers may be the same with each other, or may be different.

Next, a layer (a resin layer on the back surface side) formed by coating a coating solution containing a resin dissolved in an organic solvent, provided on the back surface, as described in Structure 3 will be explained.

As a material constituting a resin layer on the back surface, for example, an aqueous emulsion resin, a water-soluble resin, particles and organic solvent soluble resins are employed. It is preferable that the material constituting a resin layer on the back surface is the same as a material used for a layer (a resin layer on the front surface side) formed by coating a coating solution containing a resin dissolved in an organic solvent provided between the above-described ink-absorbing layer and a paper support in view of easily obtaining curl balance, but the present invention is not limited thereto. In this case, it is preferable that the thicknesses of resin layers on the front surface side and back surface side of the support are changed in consideration of the shrinkage stress of the ink-absorbing layer. Alternatively, a paper support on which a back coat layer as a resin layer is coated on the front side in advance is used, and provided may be an ink-absorbing layer and a layer formed on the opposite surface by coating a coating solution containing a resin dissolved in an organic solvent. For example, when the ink-absorbing layer and the resin layer on the front surface side are formed on the surface side of a common cast-coat paper sheet which is not cast-coated, it is also preferable that the cast-coat layer functions as a resin layer on the back surface layer. In the resin layer on the back surface side, a matting agent or an antistatic agent may also be incorporated, if desired, which may be applied in the same manner as the ink-absorbing layer.

The resin layer on the back surface side may be coated before forming the ink-absorbing layer and the resin layer on the front surface layer, or after forming those layers.

A coating method to provide a layer containing particles and a resin dissolved in an organic solvent (resin layers on the front surface side and back surface side) or an ink-absorbing layer according to the present invention can be selected from commonly known methods. For example, employed is a gravure coating method, a roll coating method, a rod-bar coating method, an air-knife coating method, a spray coating method, an extrusion coating method, a curtain coating method, or an extrusion coating method which utilizes a hopper described in U.S. Pat. No. 2,681,294.

At the time of forming an image by use of an ink-jet recording medium of this invention, ink-jet ink can be utilized, and among them, preferably utilized is water-based dye ink containing such as a water-soluble dye, water and an organic solvent.

Water-soluble dyes utilized in the present invention include such as azo dyes, methine dyes, azomethine dyes, xanthene dyes, quinone dyes, phthalocyanine dyes, triphenylmethane dyes and diphenylmethane dyes, and specific examples thereof include, for example, dyes exemplified in Japanese Patent O.P.I. Publication No. 2002-264490.

Organic solvents employed in the present invention are not specifically limited and are preferably water-soluble organic solvents which specifically include alcohols (such as methanol, ethanol, propanol, isopropanol, butanol, isobutanol, secondary butanol, tertiary butanol, pentanol, hexanol, cyclohexanol and benzyl alcohol), polyhydric alcohols (such as ethylene glycol, diethylene glycol, triethylene glycol, polyethylene glycol, propylene glycol, dipropylene glycol, polypropylene glycol, butylenes glycol, hexane diol, pentane diol, glycerin, hexane triol and thiodiglycol), polyhydric alcoholethers (ethylene glycol monomethylether, ethylene glycol monoethylether, ethylene glycol monobutylether, ethylene glycol monophenylether, diethylene glycol monomethylether, diethylene glycol monoethylether, diethylene glycol monobutylether, diethylene glycol dimethylether, propylene glycol monomethylether, propylene glycol monobutylether, ethylene glycol monomethylether acetate, triethylene glycol monomethylether, tiethylene glycol monoethylether, triethylene glycol monobutylether, triethylene glycol dimethylether, dipropylene glycol monopropylether and tripropylene glycol dimethylether), amines (such as ethanolamine, diethanolamine, triethanolamine, N-methyldiethanolamine, N-ethyldiethanolamine, morpholine, N-ethylmorpholine, ethylenediamine, triethylenetetramine, tetraethylene pentamine, polyethyleneimine, pentamethyldiethylenetriamine and tetramethylpropylenediamine), amides (such as formamide, N,N-dimethylformamide and N,N-dimethylacetoamide), heterocyclic rings (such as 2-pyrrolidone, N-methyl-2-pyrrolidone, N-cyclohexyl-2-pyrrolidone, 2-oxazolidone and 1,3-dimethyl-2-imidazolidine), sulfoxides (such as dimethylsulfoxide), sulfones (such as sulforane), sulfonates (such as sodium 1-butanesulfonate), urea, acetonitrile and acetone.

In ink of the present invention, various types of surfactants can be utilized. Surfactants employed in the present invention are not specifically limited and include, for example, anionic surfactants such as dialkylsulfo succinates, alkylnaphthalene sulfonates and fatty acid salts; nonionic surfactants such as polyoxyethylene alkylethers, polyoxyethylene alkylallylethers, acetylene glycols and polyoxyethylene-polyoxypropylene blockcopolymers; and cationic surfactants such as alkylamines and quaternary ammonium salts. Particularly, anionic surfactants and nonionic surfactants are preferably utilized.

Further, in ink of the present invention, a polymer surfactant can be utilized. For example, listed are styrene-acrylic acid-alkylester acrylate copolymer, styrene-acrylic acid copolymer, styrene-maleic acid-alkylester acrylate copolymer, a styrene-maleic acid copolymer, styrene-methacrylic acid-alkylester acrylate copolymer, styrene-methacrylic acid copolymer, styrene-maleic acid half-ester copolymer, vinylnaphthalene-acrylic acid copolymer and vinylnaphthalene-maleic acid copolymer.

In ink of the present invention, other than those explained above, well known various additives such as a viscosity controlling agent, a specific resistance controlling agent, a film forming agent, an ultraviolet absorbent, an anti-oxidant, an anti-fading agent, an anti-mold agent and anti-staining agent can be utilized by appropriate selection, depending on the purpose of improvement of ejection stability, adaptability to a print head and an ink cartridge, storage stability, an image lasting property and other various capabilities. For example, listed are oil particles of such as fluid paraffin, dioctylphthalate, tricresylphosphate and silicone oil; ultraviolet absorbents described in Japanese Patent O.P.I. Publication Nos. 57-74193, 57-87988 and 62-261476; anti-fading agents described in Japanese Patent O.P.I. Publication Nos. 57-74192, 57-87989, 60-72785, 61-146591, 1-95091 and 3-13376; and fluorescent whitening agents described in Japanese Patent O.P.I. Publication Nos. 59-42993, 59-52689, 62-280069, 61-242871 and 4-219266.

### EXAMPLE

Next, the present invention will be concretely explained referring to examples, but the present invention is not limited thereto. Herein, “part” and “%” used in the following examples represent “part by weight” and “% by weight”, respectively, unless otherwise mentioned.

### Example 1

<<Preparation of Ink-Jet Recording Medium>>

<Preparation of Ink-Jet Recording Medium 1>

(Preparation of Each Coating Solution)

<Preparation of Silica Dispersion S-1>

An aqueous solution containing 10% of cationic polymer P-1, 10% of n-propanol and 2% of ethanol was prepared. Into 150 g of thus obtained cationic polymer solution, the following were added while the liquid was stirred at 3000 rpm at ambient temperature: (i) 436 g of silica dispersion (pH: 2.6, ethanol content: 0.5%) in which 23% of fumed silica having an average primary particle diameter of 7 nm (Aerosil 300 produced by Nippon Aerosil Co., Ltd.) was homogeneously dispersed; (ii) 3.6 g of boric acid; and (iii) 0.8 g of borax.

The resulting liquid was further dispersed with a pressure of 3 kN/cm² using a high pressure homogenizer produced by Sanwa Kogyo Co., Ltd., followed by adding pure water so that the silica content was 18% to obtain silica dispersion S-1. Obtained silica dispersion S-1 was filtered with TCP-10 filter produced by ADVANTEC. The average secondary particle diameter of silica was found to be 37 nm. The average secondary particle diameter of silica was measured by diluting the silica dispersion S-1 by 50 times using a dynamic light scattering particle sizer: Zetasizer 1000HS produced by Malvern Instruments Ltd. 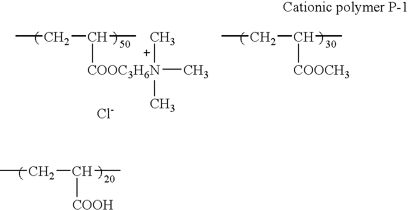
(Preparation of Resin Layer Coating Solution 1)

100 g of sodium sulfonate-containing polyurethane UR8200 produced by Toyobo, Ltd. is dissolved in 300 g of methylethylketone, 300 g of cyclohexane and 300 g of toluene to prepare resin layer coating solution 1 containing a resin dissolved in an organic solvent.

While stirring at 40° C., 500 g of above silica dispersion S-1 was gradually added into 205 g of 8% aqueous solution of polyvinyl alcohol with a polymerization degree of 3500 (PVA235 produced by Kuraray Co., Ltd.), followed by adding pure water so that the total volume was 1000 ml. Thus ink-absorbing layer coating liquid 1 was prepared.

(Preparation of Recording Medium)

Resin layer coating solution 1 was coated by a wire bar coating method on the surface side of a cast-coat layer of cast-coat paper for printing “Mirror Coat Satin Kanefuji” produced by Oji Paper Co., Ltd. (paper weight per m² of 209.3 g and surface average roughness Ra=0.12 μm) so as to give a wet thickness of 50 μm (a dry thickness of 5 μm), followed by drying to form resin layer 1 on the back surface side.

Next, above ink-absorbing layer coating solution 1 was coated onto resin layer 1 on the front surface side so as to give a wet thickness of 180 μm employing a slide hopper, and the resulting was kept in a thermostatic oven at 40° C. and 80% RH for 10 hours after drying with stepwise increasing the air flow temperature from 20 to 60° C., to prepare recording medium 1. In addition, it is confirmed that recording medium 1 prepared in the above gives the same level of texture as in silver halide photographic printing paper.

[Preparation of Recording Medium A-2]

Recording medium A-2 was prepared similarly to preparation of above recording medium 1, except that a support was changed from the cast-coat paper for printing “Mirror Coat Satin Kanefuji” produced by Oji Paper Co., Ltd. (paper weight per m² of 209.3 and Ra=0.12 μm) to art paper “ART POST” produced by Hokuetsu Paper Mills, Ltd. (paper weight per m² of 209.4 g and Ra=0.51 μm).

[Preparation of Recording Medium A-3]

Recording medium A-3 was prepared similarly to preparation of above recording medium 1, except that a support was changed from the cast-coat paper for printing “Mirror Coat Satin Kanefuji” produced by Oji Paper Co., Ltd. (paper weight per m² of 209.3 g and Ra=0.12 μm) to fine-quality paper “Shiraoi” produced by Nippon Daishowa Plate Paperboard Co., Ltd. (paper weight per m² of 209.3 g and Ra=1.5).

[Preparation of Recording Medium A-4]

Ink-absorbing layer coating solution 1 was coated on the surface side of a cast-coat layer of cast-coat paper for printing “Mirror Coat Satin Kanefuji” produced by Oji Paper Co., Ltd. (paper weight per m² of 209.3 g and surface average roughness Ra=0.12 μm) so as to give a wet thickness of 180 μm employing a slide hopper, and the resulting was kept in a thermostatic oven at 40° C. and 80% RH for 10 hours after drying with stepwise increasing the air flow temperature from 20 to 60° C., to prepare recording medium A-4.

[Preparation of Recording Medium A-5]

Recording medium A-5 was prepared similarly to preparation of above recording medium A-4, except that a support was changed from the cast-coat paper for printing “Mirror Coat Satin Kanefuji” produced by Oji Paper Co., Ltd. (paper weight per m² of 209.3 g and Ra=0.12 μm) to art paper “ART POST” produced by Hokuetsu Paper Mills, Ltd. (paper weight per m² of 209.4 g and Ra=0.51 μm).

[Preparation of Recording Medium A-6]

Recording medium A-6 was prepared similarly to preparation of above recording medium A-4, except that a support was changed from the cast-coat paper for printing “Mirror Coat Satin Kanefuji” produced by Oji Paper Co., Ltd. (paper weight per m² of 209.3 g and Ra=0.12 μm) to fine-quality paper “Shiraoi” produced by Nippon Daishowa Plate Paperboard Co., Ltd. (paper weight per m² of 209.3 g and Ra=1.5).

[Preparation of Recording Medium A-7]

Recording medium A-7 was prepared similarly to preparation of above recording medium 1, except that a support was changed from the cast-coat paper for printing “Mirror Coat Satin Kanefuji” produced by Oji Paper Co., Ltd. (paper weight per m² of 209.3 g and Ra=0.12 μm) to cast-coat paper for printing “Mirror Coat Satin Kanefuji” produced by Oji Paper Co., Ltd. (paper weight per m² of 181 g and Ra=0.10 μm).

[Preparation of Recording Medium A-8]

Super calendar finishing was conducted while controlling temperature and pressure in the cast-coat paper for printing “Mirror Coat Satin Kanefuji” produced by Oji Paper Co., Ltd. (paper weight per m² of 209.3 g and Ra=0.12 μm), to prepare high surface smoothness cast-coat paper having a surface average roughness (Ra) of 0.08 μm. Recording medium A-8 was prepared similarly to preparation of recording medium 1, except that a support was changed from the cast-coat paper for printing “Mirror Coat Satin Kanefuji” produced by Oji Paper Co., Ltd. (paper weight per m² of 209.3 g and Ra=0.12 μm) to high surface smoothness cast-coat paper.

[Preparation of Recording Medium A-9]

Recording medium A-9 was prepared similarly to preparation of above recording medium 1, except that a support was changed from the cast-coat paper for printing “Mirror Coat Satin Kanefuji” produced by Oji Paper Co., Ltd. (paper weight per m² of 209.3 g and Ra=0.12 μm) to art paper “ART POST” produced by Hokuetsu Paper Mills, Ltd. (paper weight per m² of 256 g and Ra=0.35 μm).

<<Evaluation of Recording Medium>>

Each of the above-described recording media was evaluated according to the following method.

[Evaluation of Gloss]

A blue solid image was printed on the ink-absorbing layer coating surface side of each of recording media employing an ink-jet printer PM-G800 produced by Seiko Epson Corp. In addition, each of recording media was printed after standing at 23° C. for one day.

Gloss on the ink-absorbing layer surface side of each recording medium was evaluated by comparing the gloss with that of a color paper for silver halide photography (color paper: glossy type QA paper produced by Konica Minolta Photo Imaging, Inc.), according to the following criteria.

1: Exhibiting gloss higher than the gloss of a silver halide photograph.

2: Exhibiting almost equivalent gloss in comparison to the gloss of a silver halide photograph.

3: Slightly exhibiting gloss lower than the gloss of a silver halide photograph, but suitable for practical use.

4: Slightly exhibiting gloss lower than the gloss of a silver halide photograph.

5: Exhibiting no gloss.

[Evaluation of Cockling Resistance (Printed Area)]

A black solid image was printed on each of recording media employing an ink-jet printer PM-G800 produced by Seiko Epson Corp., the resulting image surface was visually observed after standing at 25° C., and the recording sheet was evaluated for cockling resistance according to the following criteria. When a recording medium is ranked as A-C, it was evaluated as suitable for practical use.

A: Exhibiting no cockling on the surface and beauty of the surface being maintained

B: Exhibiting slight cockling on the surface, but gloss on the surface being maintained.

C: Exhibiting small cockling on the surface, but the beauty of the surface almost being maintained.

D: Exhibiting significantly large cockling on the surface and the beauty of the surface being spoiled.

[Evaluation of Cockling Resistance (Non-Printed Area)]

White background area in which each of recording media is not printed was visually observed, and the recording sheet was evaluated for cockling resistance according to the following criteria. When a recording medium is ranked as A-C, it was evaluated as suitable for practical use.

A: Exhibiting no cockling on the surface and beauty of the surface being maintained

B: Exhibiting slight cockling on the surface, but gloss on the surface being maintained.

C: Exhibiting small cockling on the surface, but the beauty of the surface almost being maintained.

D: Exhibiting significantly large cockling on the surface and the beauty of the surface being spoiled. Evaluated results are shown in Table 1.

TABLE 1

| | | | | | | | Each evaluation | | | |
|---|---|---|---|---|---|---|---|---|---|---|
| | | | Resin layer | | | Resin | result | | | |
| | | | on the front | | | layer | | Cockling | | |
| | Paper | | surface side | | | on the | | resistance | | |
| | support | | Coating | | Dry | back | | | Non- | |
| | | Ra | solution | Resin | thickness | surface | | Printed | printed | |
| *4 | Type | (μm) | No. | type | (μm) | side | Gloss | area | area | Remarks |
| 1 | *1 | 0.12 | 1 | UR | 5.0 | Provided | 2 | A | A | *a |
| | | | | 8200 | | | | | | |
| A-2 | *2 | 0.51 | 1 | UR | 5.0 | Provided | 4 | A | A | *b |
| | | | | 8200 | | | | | | |
| A-3 | *3 | 1.50 | 1 | UR | 5.0 | Provided | 5 | A | A | *b |
| | | | | 8200 | | | | | | |
| A-4 | *1 | 0.12 | — | — | — | Not | 5 | D | D | *b |
| | | | | | | provided | | | | |
| A-5 | *2 | 0.51 | — | — | — | Not | 5 | D | D | *b |
| | | | | | | provided | | | | |
| A-6 | *3 | 1.50 | — | — | — | Not | 5 | D | D | *b |
| | | | | | | provided | | | | |
| A-7 | *1 | 0.10 | 1 | UR | 5.0 | Provided | 2 | A | A | *a |
| | | | | 8200 | | | | | | |
| A-8 | *1 | 0.08 | 1 | UR | 5.0 | Provided | 2 | A | A | *a |
| | | | | 8200 | | | | | | |
| A-9 | *2 | 0.35 | 1 | UR | 5.0 | Provided | 4 | A | A | *b |
| | | | | 8200 | | | | | | |

*1: Mirror coat paper
*2: Art paper
*3: Fine-quality paper
*4: Recording medium No.
*a: Present invention
*b: Comparative example

As can be seen from Table 1, it is to be clearly understood that recording media 1, A-7 and A-8 with a support having surface average roughness in the present invention exhibit higher gloss in comparison to a support having larger surface average roughness than that of the present invention. Recording media A-4, A-5 and A-6 in which a resin layer of the present invention is not provided on the front surface side and the back surface side exhibit no gloss and cockling resistance at all.

### Example 2

[Preparation of Recording Medium B-2]

Recording medium B-2 was prepared similarly to preparation of recording medium 1 described in EXAMPLE 1, resin layer coating solution 1 containing a resin dissolved in an organic solvent is changed to resin layer coating solution 2 containing a resin dissolved in the following organic solvent, to form resin layer 2 on the front surface side and resin layer 2 on the back surface side.

(Preparation of Resin Layer Coating Solution 2)

100 g of sodium sulfonate-containing polyurethane UR8300 produced by Toyobo, Ltd. is dissolved in 300 g of methylethylketone, 300 g of cyclohexane and 300 g of toluene to prepare resin layer coating solution 2 containing a resin dissolved in an organic solvent.

[Preparation of Ink-Jet Recording Medium B-3]

Recording medium B-3 was prepared similarly to preparation of recording medium 1 described in EXAMPLE 1, resin layer coating solution 1 containing a resin dissolved in an organic solvent is changed to resin layer coating solution 3 containing a resin dissolved in the following organic solvent, to form resin layer 3 on the front surface side and resin layer 3 on the back surface side.

(Preparation of Resin Layer Coating Solution 3)

100 g of potassium sulfonate-containing polyurethane MR110 produced by Zeon Corporation is dissolved in 300 g of methylethylketone, 300 g of cyclohexane and 300 g of toluene to prepare resin layer coating solution 3 containing a resin dissolved in an organic solvent.

[Preparation of Recording Medium B-4]

Recording medium B-4 was prepared similarly to preparation of recording medium 1 described in EXAMPLE 1, resin layer coating solution 1 containing a resin dissolved in an organic solvent is changed to resin layer coating solution 4 containing a resin dissolved in the following organic solvent, to form resin layer 4 on the front surface side and resin layer 4 on the back surface side.

(Preparation of Resin Layer Coating Solution 4)

100 g of potassium sulfonate-containing polyurethane MR100 produced by Zeon Corporation is dissolved in 300 g of methylethylketone, 300 g of cyclohexane and 300 g of toluene to prepare resin layer coating solution 4 containing a resin dissolved in an organic solvent.

[Preparation of Recording Medium B-5]

Resin layer coating solution 5 containing a resin dissolved in the following organic solvent was coated by a wire bar coating method on the surface side of a cast-coat layer of cast-coat paper for printing “Mirror Coat Satin Kanefuji” produced by Oji Paper Co., Ltd. (paper weight per m² of 209.3 g and Ra=0.12 μm) so as to give a wet thickness of 50 μm, followed by drying to form resin layer 5 on the front surface side. Similarly to the back surface, following resin layer coating solution 5 was coated by a wire bar coating method so as to give a wet thickness of 60 μm, followed by drying to form resin layer 6 on the back surface side.

Next, after treating a resin layer surface on the front surface via corona discharge treatment, foregoing ink-absorbing layer coating solution 1 was coated so as to give a wet thickness of 180 μm employing a slide hopper, and the resulting was kept in a thermostatic oven at 40° C. and 80% RH for 10 hours after drying with stepwise increasing the air flow temperature from 20 to 60° C., to prepare recording medium B-5.

[Preparation of Resin Layer Coating Solution 5]

100 g of polyvinylbutyral #6000C produced by DENKI KAGAKU KOGYO KABUSHIKI KAISHA is dissolved in 900 g of methylethylketone to prepare resin layer coating solution 5 containing a resin dissolved in an organic solvent.

[Preparation of Recording Medium B-6]

Recording medium B-6 was prepared similarly to preparation of above recording medium 5, resin layer coating solution 5 containing a resin dissolved in an organic solvent is changed to resin layer coating solution 6 containing a resin dissolved in the following organic solvent, to form resin layer 6 on the front surface side and resin layer 6 on the back surface side.

[Preparation of Resin Layer Coating Solution 6]

100 g of polyvinylbutyral #3000-2, produced by DENKI KAGAKU KOGYO KABUSHIKI KAISHA, is dissolved in 900 g of methylethylketone to prepare resin layer coating solution 6 containing a resin dissolved in an organic solvent.

(Preparation of Recording Medium B-7)

Following gelatin layer coating solution 7 was coated by a wire bar coating method on the surface side of a cast-coat layer of cast-coat paper for printing “Mirror Coat Satin Kanefuji” produced by Oji Paper Co., Ltd. (paper weight per m² of 209.3 g and Ra=0.12 μm) so as to give a wet thickness of 50 μm, followed by drying to form gelatin layer 7 on the front surface side. Similarly to the back surface, gelatin layer coating solution 7 was coated by a wire bar coating method so as to give a wet thickness of 60 μm, followed by drying to form gelatin layer 7 on the back surface side.

Next, foregoing ink-absorbing layer coating solution 1 was coated onto gelatin layer 7 on the front surface side so as to give a wet thickness of 180 μm employing a slide hopper, and the resulting was kept in a thermostatic oven at 40° C. and 80% RH for 10 hours after drying with stepwise increasing the air flow temperature from 20 to 60° C., to prepare recording medium B-7.

[Preparation of Gelatin Layer Coating Solution 7]

100 g of phenylcarbamoylgelatin is dissolved in 900 g of water to prepare gelatin layer coating solution 7.

It is confirmed that above-described recording media B-2-B-7 give the same level of texture as in silver halide photographic printing paper.

<<Evaluation of Recording Medium>>

Similarly to the method described in EXAMPLE 1, evaluated are gloss and cockling resistance of printed area and non-printed area in above-described recording media B-2-B-7 and recording medium 1 prepared in EXAMPLE 1. The obtained results are shown in Table 2.

TABLE 2

| | | | | | | | | Each evaluation result | | | |
|---|---|---|---|---|---|---|---|---|---|---|---|
| | | | Resin layer on the | | | | Resin | | Cockling | | |
| | Paper | | front surface side | | | | layer on | | resistance | | |
| | support | | Coating | | Dry | Corona | the ack | | | Non- | |
| | | Ra | solution | Resin | thickness | discharge | surface | | Printed | printed | |
| *3 | Type | (μm) | No. | type | (μm) | treatment | side | Gloss | area | area | Remarks |
| 1 | *1 | 0.12 | 1 | UR 8200 | 5.0 | Not | Provided | 2 | A | A | *a |
| | | | | | | Conducted | | | | | |
| B-2 | *1 | 0.12 | 2 | UR 8300 | 5.0 | Not | Provided | 2 | A | A | *a |
| | | | | | | Conducted | | | | | |
| B-3 | *1 | 0.12 | 3 | MR 110 | 5.0 | Not | Provided | 2 | A | A | *a |
| | | | | | | Conducted | | | | | |
| B-4 | *1 | 0.12 | 4 | MR 100 | 5.0 | Not | Provided | 2 | A | A | *a |
| | | | | | | Conducted | | | | | |
| B-5 | *1 | 0.12 | 5 | PVB | 5.0 | Conducted | Provided | 3 | A | A | *a |
| | | | | #6000C | | | | | | | |
| B-6 | *1 | 0.12 | 6 | PVB | 5.0 | Conducted | Provided | 3 | A | A | *a |
| | | | | #3000-2 | | | | | | | |
| B-7 | *1 | 0.12 | 7 (*2) | Gelatin | 5.0 | Not | Provided | 3 | D | D | *b |
| | | | | | | Conducted | | | | | |

*1: Mirror coat paper
(*2): Gelatin layer coating solution 7,
PVB: Polyvinyl butyral
*3: Recordingd medium No.,
*a: Present invention
*b: Comparative example

As can be seen from Table 2, it is to be understood that the recording medium with a resin layer of the present invention exhibits excellent cockling resistance in comparison to the comparative example in which a gelatin layer is provided in place of a resin layer. It is also to be understood that a resin layer of the present invention shuts off moisture (water or alcohol) contained in an ink-absorbing layer coating solution, and also contained in ink during printing in order to avoid occurrence of cockling of a paper support.

### Example 3

[Preparation of Recording Medium C-2]

Foregoing Resin layer coating solution 1 was coated by a wire bar coating method on the surface side of a cast-coat layer of cast-coat paper for printing “Mirror Coat Satin Kanefuji” produced by Oji Paper Co., Ltd. (paper weight per m² of 209.3 g and Ra=0.12 μm) so as to give a wet thickness of 10 μm (a dry thickness of 1.0 μm), followed by drying to form resin layer 2C on the front surface side. Similarly to the back surface, resin layer coating solution 1 was coated by a wire bar coating method so as to give a wet thickness of 20 μm (a dry thickness of 2.0 μm), followed by drying to form resin layer 2C on the back surface side.

Next, foregoing ink-absorbing layer coating solution 1 was coated onto resin layer 2C on the front surface side so as to give a wet thickness of 180 μm employing a slide hopper, and the resulting was kept in a thermostatic oven at 40° C. and 80% RH for 10 hours after drying with stepwise increasing the air flow temperature from 20 to 60° C., to prepare recording medium C-2.

[Preparation of Recording Medium C-3]

Foregoing Resin layer coating solution 1 was coated by a wire bar coating method on the surface side of a cast-coat layer of cast-coat paper for printing “Mirror Coat Satin Kanefuji” produced by Oji Paper Co., Ltd. (paper weight per m² of 209.3 g and Ra=0.12 μm) so as to give a wet thickness of 3 μm (a dry thickness of 0.3 μm), followed by drying to form resin layer 3C on the front surface side. Similarly to the back surface, resin layer coating solution 1 was coated by a wire bar coating method so as to give a wet thickness of 10 μm (a dry thickness of 1.0 μm), followed by drying to form resin layer 3C on the back surface side.

Next, foregoing ink-absorbing layer coating solution 1 was coated onto resin layer 3C on the front surface side so as to give a wet thickness of 180 μm employing a slide hopper, and the resulting was kept in a thermostatic oven at 40° C. and 80% RH for 10 hours after drying with stepwise increasing the air flow temperature from 20 to 60° C., to prepare recording medium C-3.

[Preparation of Recording Medium C-4]

Foregoing Resin layer coating solution 1 was coated by a wire bar coating method on the surface side of a cast-coat layer of cast-coat paper for printing “Mirror Coat Satin Kanefuji” produced by Oji Paper Co., Ltd. (paper weight per m² of 209.3 g and Ra=0.12 μm) so as to give a wet thickness of 80 μm (a dry thickness of 8.0 μm), followed by drying to form resin layer 4C on the front surface side. Similarly to the back surface, resin layer coating solution 1 was coated by a wire bar coating method so as to give a wet thickness of 90 μm (a dry thickness of 9.0 μm), followed by drying to form resin layer 4C on the back surface side.

Next, foregoing ink-absorbing layer coating solution 1 was coated onto resin layer 4C on the front surface side so as to give a wet thickness of 180 μm employing a slide hopper, and the resulting was kept in a thermostatic oven at 40° C. and 80% RH for 10 hours after drying with stepwise increasing the air flow temperature from 20 to 60° C., to prepare recording medium C-4.

[Preparation of Recording Medium C-5]

Foregoing Resin layer coating solution 1 was coated by a wire bar coating method on the surface side of a cast-coat layer of cast-coat paper for printing “Mirror Coat Satin Kanefuji” produced by Oji Paper Co., Ltd. (paper weight per m² of 209.3 g and Ra=0.12 μm) so as to give a wet thickness of 130 μm (a dry thickness of 13.0 μm), followed by drying to form resin layer 5C on the front surface side. Similarly to the back surface, resin layer coating solution 1 was coated by a wire bar coating method so as to give a wet thickness of 150 μm (a dry thickness of 15.0 μm), followed by drying to form resin layer 5C on the back surface side.

Next, foregoing ink-absorbing layer coating solution 1 was coated onto resin layer 5C on the front surface side so as to give a wet thickness of 180 μm employing a slide hopper, and the resulting was kept in a thermostatic oven at 40° C. and 80% RH for 10 hours after drying with stepwise increasing the air flow temperature from 20 to 60° C., to prepare recording medium C-5.

[Preparation of Recording Medium C-6]

Foregoing Resin layer coating solution 1 was coated by a wire bar coating method on the surface side of a cast-coat layer of cast-coat paper for printing “Mirror Coat Satin Kanefuji” produced by Oji Paper Co., Ltd. (paper weight per m² of 209.3 g and Ra=0.12 μm) so as to give a wet thickness of 50 μm (a dry thickness of 5.0 μm), followed by drying to form resin layer 6C on the front surface side.

Next, foregoing ink-absorbing layer coating solution 1 was coated onto resin layer 6C on the front surface side so as to give a wet thickness of 180 μm employing a slide hopper, and the resulting was kept in a thermostatic oven at 40° C. and 80% RH for 10 hours after drying with stepwise increasing the air flow temperature from 20 to 60° C., to prepare recording medium C-6.

[Preparation of Recording Medium D-2]

Recording medium D-2 was prepared similarly to preparation of above recording medium C-2, resin layer coating solution 1 is changed to resin layer coating solution 2 prepared in EXAMPLE 2, to produce recording medium D-2.

[Preparation of Recording Medium D-3]

Recording medium D-3 was prepared similarly to preparation of above recording medium C-3, resin layer coating solution 1 is changed to foregoing resin layer coating solution 2, to produce recording medium D-3.

[Preparation of Recording Medium D-4]

Recording medium D-4 was prepared similarly to preparation of above recording medium C-4, resin layer coating solution 1 is changed to forgoing resin layer coating solution 2, to produce recording medium D-4.

[Preparation of Recording Medium D-5]

Recording medium D-5 was prepared similarly to preparation of above recording medium C-5, resin layer coating solution 1 is changed to foregoing resin layer coating solution 2, to produce recording medium D-5.

[Preparation of Recording Medium D-6]

Recording medium D-4 was prepared similarly to preparation of above recording medium C-6, resin layer coating solution 1 is changed to foregoing resin layer coating solution 2, to produce recording medium D-6.

Each recording medium configuration is shown in Table 3.

TABLE 3

| | | | | | | Resin layer on | |
|---|---|---|---|---|---|---|---|
| | | | Resin layer on the | | | the back | |
| | Paper | | front surface side | | | surface side | |
| | support | | Coating | | Dry | Provided | Dry |
| Recording | | Ra | solution | | thickness | or not | thickness |
| medium No. | Type | (μm) | No. | Resin type | (μm) | provided | (μm) |
| 1 | Mirror | 0.12 | 1 | UR8200 | 5.0 | Provided | 6.0 |
| | coat | | | | | | |
| | paper | | | | | | |
| C-2 | Mirror | 0.12 | 1 | UR8200 | 1.0 | Provided | 2.0 |
| | coat | | | | | | |
| | paper | | | | | | |
| C-3 | Mirror | 0.12 | 1 | UR8200 | 0.3 | Provided | 1.0 |
| | coat | | | | | | |
| | paper | | | | | | |
| C-4 | Mirror | 0.12 | 1 | UR8200 | 8.0 | Provided | 9.0 |
| | coat | | | | | | |
| | paper | | | | | | |
| C-5 | Mirror | 0.12 | 1 | UR8200 | 13.0 | Provided | 15.0 |
| | coat | | | | | | |
| | paper | | | | | | |
| C-6 | Mirror | 0.12 | 1 | UR8200 | 5.0 | Not | — |
| | coat | | | | | provided | |
| | paper | | | | | | |
| B-2 | Mirror | 0.12 | 2 | UR8300 | 5.0 | Provided | 6.0 |
| | coat | | | | | | |
| | paper | | | | | | |
| D-2 | Mirror | 0.12 | 2 | UR8300 | 1.0 | Provided | 2.0 |
| | coat | | | | | | |
| | paper | | | | | | |
| D-3 | Mirror | 0.12 | 2 | UR8300 | 0.3 | Provided | 1.0 |
| | coat | | | | | | |
| | paper | | | | | | |
| D-4 | Mirror | 0.12 | 2 | UR8300 | 8.0 | Provided | 9.0 |
| | coat | | | | | | |
| | paper | | | | | | |
| D-5 | Mirror | 0.12 | 2 | UR8300 | 13.0 | Provided | 15.0 |
| | coat | | | | | | |
| | paper | | | | | | |
| D-6 | Mirror | 0.12 | 2 | UR8300 | 5.0 | Not | — |
| | coat | | | | | provided | |
| | paper | | | | | | |

<<Evaluation of Recording Medium>>

Similarly to the method described in EXAMPLE 1, gloss and cockling resistance of printed area and non-printed area in above-described recording media C-2-C-6 and D-2-D-6, and recording medium 1 prepared in EXAMPLE 1 and recording medium B-2 prepared in EXAMPLE 2 were evaluated, and ink absorbability, printing stain resistance, and texture were also evaluated according to the following method.

[Evaluation of Ink Absorbability]

A green solid image was printed of each recording medium at 23° C. and 55% RH employing an ink-jet printer PM-G800 produced by Seiko Epson Corp. In addition, each recording medium was printed after standing at 23° C. for one day.

Next, solid image printed area of each recording medium was visually observed to evaluate ink absorbability via beading resistance. When a recording medium is ranked as 1-3, it was evaluated as suitable for practical use.

1: No unevenness in solid image was recognized when observed at a distance of 40 cm.

2: Slight unevenness in solid image was recognized when observed at a distance of 40 cm, but no unevenness was recognized when observed at a distance of 45 cm.

3: Slight unevenness in solid image was recognized when observed at a distance of 50 cm, but no unevenness was recognized when observed at a distance of 65 cm.

4: Slight unevenness in solid image was recognized when observed at a distance of 65 cm.

5: Unevenness was clearly recognized when observed at a distance of 65 cm.

<Evaluation for Printing Stain Resistance>

Each recording medium was cut into 40 postcard size sheets, and a cyan solid image was printed onto the 40 postcard size sheets employing an ink-jet printer PM-G800 produced by Seiko Epson Corp., then, examined was whether stain of the sheets is generated due to contact with the printer head during printing. When a recording medium is heavily curled, the edge of the recording medium was stained, since the printer head touches the recording medium.

A: No stain on the edge was observed.

B: A slight stain on the edge was observed on 1-3 sheets out of 40 sheets.

c: A slight stain on the edge was observed on 4-8 sheets out of 40 sheets.

D: A large notable stain on the edge was observed on 2 or more sheets out of 40 sheets.

[Evaluation of Texture]

(Measurement of Stiffness)

A stiffness measuring apparatus, based on a method in conformity with a creep test method of JIS K 7116 (ISO 899-2), was produced to evaluated bending creep with the 3 point load by a compressing load. The stiffness value in the present invention is the value obtained by representing the bending creep via the above test method in terms of a load. Each recording medium was cut into a strip of 10 mm×150 mm in size, supported so as to give a width of 120 mm in a long-length direction, and fixed at the point where an angle between a horizontal plane and a paper sheet is 100, by moving so as to bring two supported points closer. Next, a load value at the time when a peak portion is compressed 10 mm is specified to be the stiffness value. Relative values with respect to a stiffness value of 100 are shown in Table 4 for recording media C-2-C-6, B-2, and D-2-D-6.

(Evaluation Relating to Visual Sense and Tactile Sense)

Texture during watching and touching with each recording medium was evaluated to be classified, as shown below.

Sufficient texture: Exhibiting texture equivalent to that of silver halide photographic paper.

Slight grainy feeling: Exhibiting grainy feeling slightly, but texture equivalent to that of silver halide photographic paper.

Slight insufficient stiffness: Exhibiting insufficient stiffness slightly, but texture equivalent to that of silver halide photographic paper.

Grainy feeling: Exhibiting grainy feeling, but practically with no problem.

Low stiffness: Exhibiting low stiffness, but practically with no problem.

The evaluated results are shown in Table 4.

TABLE 4

| | Each evaluation result | | | | | | |
|---|---|---|---|---|---|---|---|
| | | Cockling | | | | | |
| | | resistance | | | | Texture | |
| | | | Non- | | | | Visual sense |
| | | Printed | printed | Ink | Printing stain | | and |
| *1 | Gloss | area | area | absorbability | resistance | Stiffness | tactile sense |
| 1 | 2 | A | A | 2 | A | 100 | Sufficient |
| | | | | | | | texture |
| C-2 | 2 | A | A | 2 | A | 85 | Sufficient |
| | | | | | | | texture |
| C-3 | 2 | C | C | 2 | A | 74 | Slight in- |
| | | | | | | | texture |
| C-4 | 2 | A | A | 2 | A | 113 | Slight |
| | | | | | | | grainy |
| | | | | | | | feeling |
| C-5 | 2 | A | A | 2 | B | 148 | Grainy |
| | | | | | | | feeling |
| C-6 | 2 | C | C | 2 | C | 94 | Sufficient |
| | | | | | | | texture |
| B-2 | 2 | A | A | 2 | A | 93 | Sufficient |
| | | | | | | | texture |
| D-2 | 2 | A | A | 2 | A | 80 | Sufficient |
| | | | | | | | texture |
| D-3 | 2 | C | C | 2 | A | 56 | Slight in- |
| | | | | | | | texture |
| D-4 | 2 | A | A | 2 | A | 112 | Slight |
| | | | | | | | grainy |
| | | | | | | | feeling |
| D-5 | 2 | A | A | 2 | B | 136 | Slight |
| | | | | | | | grainy |
| | | | | | | | feeling |
| D-6 | 2 | B | B | 2 | C | 85 | Sufficient |
| | | | | | | | texture |

*1: Recording medium No.

As can be seen from Table 4, it is to be understood that any of the recording media exhibits excellent gloss as well as ink absorbability cockling resistance. It is also to be understood that recording media having a dry thickness of 0.5-10 μm of a resin layer on the front or back surface side exhibit not only excellent cockling resistance, but also excellent printing stain resistance accompanied with a curl characteristic.

Recording media having a resin layer on the back surface side exhibit superior cockling resistance because of shutting off moisture penetration from the back surface, as well as superior printing stain resistance accompanied cockling resistance.

In addition, any of recording media of the present invention having a dry thickness of 0.5-20 μm of a resin layer exhibits sufficient texture practically with no problem. In the case of a dry thickness of at least 0.5 μm, stiffness results in sufficient texture, and In the case of a dry thickness of at most 20 μm, less grainy feeling like paper results in sufficient texture.

### Example 4

[Preparation of Recording Medium E-2]

Foregoing Resin layer coating solution 1 was coated by a wire bar coating method on the surface side of a cast-coat layer of cast-coat paper for printing “Mirror Coat Satin Kanefuji” produced by Oji Paper Co., Ltd. (paper weight per m² of 209.3 g and Ra=0.12 μm) so as to give a wet thickness of 50 μm (a dry thickness of 5.0 μm), followed by drying to form resin layer E2 on the front surface side. Similarly to the back surface, resin layer coating solution 1 was coated by a wire bar coating method so as to give a wet thickness of 60 μm (a dry thickness of 6.0 μm), followed by drying to form resin layer E2 on the back surface side.

Next, following ink-absorbing layer coating solution 2 was coated onto resin layer E2 on the front surface side so as to give a dry thickness of 20 μm, and the resulting was kept in a thermostatic oven at 38° C. and 90% RH for 10 hours after conducting a drying process at 38° C. and 90% RH for 5 minutes, followed by another drying process at 120° C. to prepare recording medium E-2.

(Preparation of Ink-Absorbing Layer Coating Solution 2)

45 g of cyclohexanol was added into 100 g of an 8% methylcellosolve solution of cellulose acetate (an oxidation degree of 55 and a viscosity-average polymerization degree of 170) to prepare ink-absorbing layer coating solution 2.

[Preparation of Recording Medium E-3]

Foregoing Resin layer coating solution 1 was coated by a wire bar coating method on the surface side of a cast-coat layer of cast-coat paper for printing “Mirror Coat Satin Kanefuji” produced by Oji Paper Co., Ltd. (paper weight per m² of 209.3 g and Ra=0.12 μm) so as to give a wet thickness of 50 μm (a dry thickness of 5.0 μm), followed by drying to form resin layer E3 on the front surface side. Similarly to the back surface, resin layer coating solution 1 was coated by a wire bar coating method so as to give a wet thickness of 60 μm (a dry thickness of 6.0 μm), followed by drying to form resin layer E3 on the back surface side.

Next, following ink-absorbing layer coating solution 3 was coated onto resin layer E3 on the front surface side so as to give a wet thickness of 100 μm employing a slide hopper, and the resulting was kept in a thermostatic oven at 40° C. and 80% RH for 10 hours after drying with stepwise increasing the air flow temperature from 20 to 60° C., to prepare recording medium E-3.

(Preparation of Ink-Absorbing Layer Coating Solution 3)

40 g of phenylcalbamoylated gelatin, 25 g of polyvinyl pirolidone (a molecular weight of 360,000), 12 g of polyethylene oxide (a molecular weight of 100,000), 1 g of surfactant (Emulgen 120 produced by Kao Corporation), 2.1 g of Tetrakis (vinylsulfonylmethyl)methane were mixed in 800 g of pure water one after the other, and dissolved to prepare ink-absorbing layer coating solution 3.

<<Evaluation of Recording Medium>>

Similarly to the methods described in EXAMPLE 1 and EXAMPLE 3, evaluated are gloss, cockling resistance of printed area and non-printed area, and ink absorbability in above-described recording media E-2 and E-3, and recording medium 1 produced in EXAMPLE 1. The obtained results are shown in Table 5.

TABLE 5

| | | | | | | | | Each evaluation | | | |
|---|---|---|---|---|---|---|---|---|---|---|---|
| | | | Resin layer on | | | | | result | | | |
| | | | the front surface | | | | Resin | | Cockling | | |
| | Paper | | side | | | Type of | layer on | | resistance | | |
| Recording | support | | Coating | | Dry | ink- | the back | | | Non- | |
| medium | | Ra | solution | Resin | thickness | absorbing | surface | | Printed | printed | |
| No. | Type | (μm) | No. | type | (μm) | layer | side | Gloss | area | area | *2 |
| 1 | *1 | 0.12 | 1 | UR8200 | 5.0 | Porous | Provided | 2 | A | A | 2 |
| | | | | | | structure | | | | | |
| | | | | | | type | | | | | |
| E-2 | *1 | 0.12 | 1 | UR8200 | 5.0 | Polymer | Provided | 2 | A | A | 3 |
| | | | | | | porous | | | | | |
| | | | | | | layer | | | | | |
| | | | | | | type | | | | | |
| E-3 | *1 | 0.12 | 1 | UR8200 | 5.0 | Swelling | Provided | 1 | A | A | 4 |
| | | | | | | type | | | | | |

*1: Mirror coat paper
*2: Ink absorbability

As can be seen from Table 5, it is to be understood that an ink-absorbing layer is a porous layer in which pores are made from inorganic particles and hydrophilic binder, whereby a reasonable level of ink absorbability accompanied with excellent cockling resistance and gloss can be obtained.

### Example 5

[Preparation of Recording Medium F-2]

Foregoing ink-absorbing layer coating solution 1 was coated onto a paper support covered by the following polyethylene so as to give a wet thickness of 180 μm employing a slide hopper, and the resulting was kept in a thermostatic oven at 40° C. and 80% RH for 10 hours after drying with stepwise increasing the air flow temperature from 20 to 60° C., to prepare recording medium F-2.

The photographic raw paper surface of 170 g/m² of a usable paper support covered by polyethylene having a moisture content of 8% was coated by extruding dissolved polyethylene containing 6% of anatase type titanium oxide to give an extruded thickness of 35 μm, and the back surface was also coated by extruding polyethylene having 40 μm in thickness to give an extruded thickness of 35 μm. Gelatin was coated to prepare a subbing layer so as to give 0.05 g per 1 m² of recording paper sheet after corona-discharging on the front surface side.

A cyan solid image was printed in above-described recording medium F-2 and recording medium 1 produced in EXAMPLE 1 employing an ink-jet printer PM-G800 produced by Seiko Epson Corp., and the printed surface was placed at an angle of 45° with respect to an outside floor facing south for 3 weeks. There were 15 days of clear weather and 8 days of rainy weather. It is to be clearly understood by examining outdoor durability in this manner that recording medium 1 of the present invention exhibits excellent outdoor durability since recording medium F-2 results in producing a problem caused by dropping of printed images, whereas no failure such as scratches is observed on the surface of recording medium 1. In addition, recording medium 1 and recording medium F-2 also exhibited excellent gloss, cockling resistance (printed area and non-printed area), and ink absorbability.

[Effect of the Invention]

According to the present invention, provided can be an ink-jet recording medium and a manufacturing method thereof exhibiting excellent outdoor durability, high gloss, and high image quality, accompanied with excellent cockling resistance.

What is claimed is:

1. An ink-jet recording medium comprising:
a support made of cellulose pulp as a component, having surface roughness Ra of at least 0.05 μm and at most 0.20 μm when a reference length is 4 mm, and a cut-off value is 0.8 mm;
a layer formed by coating a coating solution containing a resin dissolved in an organic solvent, provided on the support; and
an ink-absorbing layer is provided on the layer formed by coating the coating solution containing the resin dissolved in the organic solvent.

2. An ink-jet recording medium comprising:
a support made of cellulose pulp as a component, having surface roughness Ra of at least 0.05 μm and at most 0.20 μm when a reference length is 4 mm, and a cut-off value is 0.8 mm;
a layer having a thickness of at least 0.50 μm and at most 20 μm, formed by coating a coating solution containing a resin dissolved in an organic solvent, provided on the support; and
an ink-absorbing layer is provided on the layer having a thickness of at least 0.50 μm and at most 20 μm.

3. The ink-jet recording medium of claim 1,
wherein a layer is formed by coating a coating solution containing a resin dissolved in an organic solvent on an opposite surface of a support surface on which the layer is formed by coating the coating solution containing the resin dissolved in the organic solvent.

4. The ink-jet recording medium of claim 1,
wherein the ink-absorbing layer is formed by coating a coating solution in which water or alcohol is used as a solvent.

5. The ink-jet recording medium of claim 1,
wherein the resin dissolved in the organic solvent contains a hydrophilic group.

6. The ink-jet recording medium of claim 1,
wherein the ink-absorbing layer is a porous ink-absorbing layer.

7. The ink-jet recording medium of claim 6,
wherein the porous ink-absorbing layer contains at least inorganic particles and organic binder.

8. The ink-jet recording medium of claim 1,
wherein the support is made of cast-coat paper.

9. A method of manufacturing an ink-jet recording medium comprising:
a support made of cellulose pulp as a component, having surface roughness Ra of at least 0.05 μm and at most 0.20 μm when a reference length is 4 mm, and a cut-off value is 0.8 mm;
a layer formed by coating a coating solution containing a resin dissolved in an organic solvent, provided on the support; and
an ink-absorbing layer is provided on the layer formed by coating the coating solution containing the resin dissolved in the organic solvent.

10. A method of manufacturing an ink-jet recording medium comprising:
a support made of cellulose pulp as a component, having surface roughness Ra of at least 0.05 μm and at most 0.20 μm when a reference length is 4 mm, and a cut-off value is 0.8 mm;
a layer having a thickness of at least 0.50 μm and at most 20 μm, formed by coating a coating solution containing a resin dissolved in an organic solvent, provided on the support; and
an ink-absorbing layer is provided on the layer having a thickness of at least 0.50 μm and at most 20 μm.

11. The method of manufacturing an ink-jet recording medium of claim 9,
wherein a layer is formed by coating a coating solution containing a resin dissolved in an organic solvent on an opposite surface of a support surface on which the layer is formed by coating the coating solution containing the resin dissolved in the organic solvent.

12. The method of manufacturing an ink-jet recording medium of claim 9,
wherein the ink-absorbing layer is formed by coating a coating solution in which water or alcohol is used as a solvent.

13. The method of manufacturing an ink-jet recording medium of claim 9,
wherein the resin dissolved in the organic solvent contains a hydrophilic group.

14. The method of manufacturing an ink-jet recording medium of claim 9,
wherein the ink-absorbing layer is a porous ink-absorbing layer.

15. The method of manufacturing an ink-jet recording medium of claim 14,
wherein the porous ink-absorbing layer contains at least inorganic particles and organic binder.

16. The method of manufacturing an ink-jet recording medium of claim 9,
wherein the support is made of cast-coat paper.
